(19) United States
(12) Patent Application Publication
(10) Pub. No.: US 2004/0070476 A1
(43) Pub. Date: Apr. 15, 2004

(54) Magnetic head apparatus

(75) Inventors: Yutaka Murakami, Osaka (JP); Hironori Tomita, Nara (JP); Kenji Kubo, Nara (JP)

Correspondence Address: MERCHANT & GOULD PC, P.O. BOX 2903, MINNEAPOLIS, MN, 55402-0903, US

(73) Assignee: Matsushita Electric Industrial Co., Ltd., Kadoma-shi (JP)

(21) Appl. No.: 10/650,442

(22) Filed: Aug. 28, 2003

(30) Foreign Application Priority Data
Sep. 2, 2002 (JP) 2002-256516

(51) Int. Cl. H01F 21/00

(52) U.S. Cl. 336/110

(57) ABSTRACT

A magnetic head apparatus with which a magneto-optical recording and reproducing apparatus can be made thin is provided. The magnetic head apparatus includes: a supporting material having an elastic portion; a magnetic head hoisting and lowering member capable of being brought into contact with and separating from the supporting material; a magnetic head pressing member capable of being brought into contact with and separating from the supporting material of a pressing portion. The head main body is capable of moving between a first position in which the head main body approaches or is brought into contact with the information recording medium and a second position in which the head main body is far away from the information recording medium. While the head main body moves between the first position and the second position, the magnetic head hoisting and lowering member is brought into contact with the supporting material; and the pressing portion is brought into contact with the elastic portion, and the contact position of the pressing portion is closer to the side of the fixing position of the supporting material than the position in which the magnetic head hoisting and lowering member is brought into contact with the supporting material. In the second position, due to the pressing of the elastic portion, the elastic portion is elastically deformed toward the side of the information recording medium.

### BACKGROUND OF THE INVENTION

1. Field of the Invention

The present invention relates to a magnetic head apparatus. In particular, it relates to a magnetic head apparatus with which a magneto-optical recording and reproducing apparatus or a magnetic head apparatus can be made thin.

2. Description of the Related Art

A magneto-optical recording and reproducing apparatus includes a magneto-optical disk that is an information recording medium that can be operated to rotate by a disk rotation driving mechanism. At one surface of the magneto-optical disk, an optical head for emitting a light beam with which a magneto-optical recording layer of the information recording medium is irradiated is placed. At another surface of the magneto-optical disk, a magnetic head for applying an external magnetic field to the magneto-optical recording layer is placed opposing the optical head.

The magneto-optical recording and reproducing apparatus applies a magnetic field, the direction of which is modulated in accordance with an information signal to be recorded, to a magneto-optical recording layer of the rotated magneto-optical disk from the magnetic head, and collects light beams emitted from the optical head so as to carry out irradiation.

A portion in which a coercive force is lost as being heated up to the Curie temperature or higher by this light beam irradiation is magnetized in accordance with the direction of the magnetic field applied from the magnetic head. Then, the temperature of the portion is reduced to the Curie temperature or lower due to the relative movement of a light beam by the rotation of the magneto-optical disk, and the direction of this magnetization is fixed. Thereby, recording of an information signal is carried out.

The magneto-optical disk wobbles easily because it is operated to rotate. Therefore, the magnetic head is provided with a head main body at the tip of a supporting material capable of swinging in the direction of the wobbling of the magneto-optical disk. To this head main body, a magnetic field application portion is attached, and this head main body includes a slider that slides in contact with the magneto-optical disk or floats with a subtle distance maintained with respect to the magneto-optical disk.

The magnetic head may take a first position and a second position. The first position is in a state of recording in which the slider slides in contact with the magneto-optical disk or floats with a subtle distance maintained with respect to the magneto-optical disk. The second position is in a reproduction state in which a swinging edge of the supporting material and the head main body are separated from the magneto-optical disk by a magnetic head hoisting and lowering device of the magneto-optical disk apparatus.

A conventional magnetic head apparatus will be explained with reference to FIGS. 44 to 47. FIG. 44 is a plan view showing an example of a conventional magnetic head apparatus. FIG. 45 is a cross-sectional side view showing the magnetic head apparatus in the first position (in the recording state) taken on line X-X in FIG. 44. FIG. 46 is a cross-sectional view showing the magnetic head apparatus in the second position (in the reproducing state) taken on line X-X in FIG. 44. FIG. 47 is a side cross-sectional view showing a head main body of the magnetic head shown in FIG. 44.

A conventional magnetic head apparatus includes a head main body 5, a thin supporting material 6 for pressing a sliding portion 17 thereof onto the surface of a magnet-optical disk 1, and a fixing material 7 attached to one end of the supporting material 6. To another end of the supporting material 6, the head main body 5 is attached by way of adhesion, welding, or the like.

As shown in FIG. 47, the head main body 5 is produced as follows. A magnetic head element 15 is formed by attaching a wound coil 14 to a central magnetic pole of an E-shaped magnetic core 13 made of soft magnetic substance such as ferrite, etc. Then, this magnetic head element 15 is integrated into a slider 16 that is provided with a sliding portion 17 capable of sliding in a direct contact with the magneto-optical disk 1 and that is made of a resin having a an excellent sliding property such as, for example, polyphenylene sulfide, liquid crystal polymer, etc. by way of adhesive fixing, resin integration molding, or the like.

The supporting material 6 is made of a thin film of, for example, SUS304, BeCu, etc.

The supporting material 6 is fixed to the fixing material 7 at one end and follows the wobbling of the magneto-optical disk 1, and includes a first spring system 10, an interchange portion 9 and a second spring system 8. The first spring system 10 is a first elastic portion for applying a load to the head main body in the direction of the magneto-optical disk 1 in the first position in which recording on the magneto-optical disk 1 is carried out. The interchange portion 9 is a rigid portion tilting at a predetermined angle from the first spring system 10 so that it does not interfere with a cartridge 2 and having drawing ribs 11 formed by extrusion at both sides in the width direction. The second spring system 8 is a second elastic portion extending from the interchange portion 9 so as to follow the surface shape of the magneto-optical disk 1.

A flexible printed board 3 is adhered to the head body 5 on one end and adhered to the proximity of the fixing material 7 of the supporting material 6 at another end. To one end of the flexible printed board 3, both ends of a lead wire of the coil 14 are soldered. Another end is connected to the driving circuit of the magnetic head not shown.

The fixing material 7 is made of a metal plate of, for example, iron, stainless steel, etc.

The fixing material 7 fixes one end of the supporting material 6 and is attached to the linking member 19 for linking a magnetic head 4 and an optical head (not shown) via a shaft 18 in a manner capable of turning so as to be biased in the direction of the magneto-optical disk 1 by a spring, etc.

Next, a magnetic head hoisting and lowering device for moving the magnetic head from the first position to the second position will be explained.

A lift mechanism 220 is placed between a holder 23 for holding the magneto-optical disk 1, corresponding to a loaded information recording medium and a cartridge 2, and a magnetic head 4 in a manner in which the lift mechanism is attached to the holder 23 capable of turning a hoisting and lowering turning axis 226. To the holder 23, a slide member 24 is attached. The holder 23 can slide in the direction of an arrow a or an arrow b in FIG. 44 (in the direction of Y in FIGS. 44 to 47) by a hoisting and lowering driving portion 25 including a motor and a gear, and the like, which are attached to the holder 23. In the lift mechanism 220, a biasing force is applied to the slide member 24 by a spring, etc. (not shown). A cam mechanism is provided in a portion in which the slide member 24 is brought into contact with the lift mechanism 220. The lift mechanism 220 and slide member 24 are made of a thin metal plate such as, for example, stainless steel, iron, etc. or resin. In the portion in which the lift mechanism 220 is brought into contact with the magnetic head 4 in the second position, a hoisting and lowering portion 221 having a curved shape is placed.

When the magnetic head is in the first position (recording position), that is, in a state in which the sliding portion 17 slides in contact with the magneto-optical disk 1, by the first spring system 8 for applying a load to the head main body 5 in the direction in which it is brought into contact with the magneto-optical disk 1 and the second spring system 10 displacing in accordance with the wobbling of the magneto-optical disk 1 or the change of the surface shape, the sliding portion 17 follows the wobbling of the magneto-optical disk 1 or the change of the surface shape so that they are always in sliding contact with each other.

At this time, the lift mechanism 220 allows the hoisting and lowering portion 221 to evacuate to the side of the magnet-optical disk 1 in order not to be brought into contact with the magneto-optical head 4.

In the movement of the magnetic head from the first position (recording position) to the second position (reproducing position), the slide member 24 slides by a hoisting and lowering driving portion 25 in the direction of an arrow b shown in FIG. 44, turns the lift mechanism 220 by a cam mechanism around a hoisting and lowering turning axis 226, and moves the hoisting and lowering portion 221 in the direction of separation from the magneto-optical disk 1. The hoisting and lowering member 221 is brought in contact with the interchange portion of the magnetic head 4 and allows the head main body 5 to separate from the magneto-optical disk 1 to be lifted to the position having space H2 with respect to the cartridge 2, that is, the second position. At this time, the turning center for separating the head main body 5 from the magneto-optical disk 1 is an end portion (P1) of the first spring system 10 at the side of the fixing material 7.

### SUMMARY OF THE INVENTION

In recent years, in accordance with the prevalence of miniaturized portable equipment, an apparatus has been increasingly thinned, and the magnetic head and the height H3 from the upper surface of a cartridge to a fixing member has become thin. However, in the configuration of a conventional magnetic head apparatus, the amount of displacement of the hoisting and lowering portion necessary to move the head main body to the second placement is large in order to separate the head main body from the magneto-optical disk sufficiently, and the hoisting and lowering portion itself was required to be largely separated from the magneto-optical disk. Furthermore, the folding portion of the magnetic head protrudes from the fixing material, and thus the magneto-optical recording and reproducing apparatus cannot be thinned.

With the foregoing in mind, it is an object of the present invention to provide a magnetic head apparatus with which a magneto-optical recording and reproducing apparatus can be thinned.

In order to achieve the above-mentioned object, the first magnetic head apparatus of the present invention includes a supporting material comprising a head main body for applying a magnetic field to an information recording medium attached to one end with a second end fixed, and an elastic portion, which is capable of being elastically deformed, between the head main body and the fixed second end. A magnetic head hoisting and lowering member is disposed between the supporting material and the information recording medium and fixed in a manner capable of being brought into contact with and separating from the supporting material. A magnetic head pressing member comprises a pressing portion facing a surface opposite side to the information recording medium in both sides of the supporting material and fixed in a manner capable of being brought into contact with and separating from the supporting material. In the magnetic head apparatus, the head main body is capable of moving between a first position in which the head main body approaches or is brought into contact with the information recording medium so as to record or reproduce information and a second position in which the head main body is far away from the information recording medium as compared with the first position. While the head main body moves from the first position to the second position, the magnetic head hoisting and lowering member approaches and is brought into contact with the supporting material;

and the pressing portion of the magnetic head pressing member approaches the supporting material and is brought into contact with the elastic portion. A position in which the pressing portion and the elastic portion are contact with each other is closer to the side of the fixing position of the supporting material than the position in which the magnetic head hoisting and lowering member and the supporting material are brought into contact with each other; and in the second position, the pressing portion presses the elastic portion, so that the elastic portion is elastically deformed toward the side of the information recording medium.

Next, the second magnetic head apparatus according to the present invention includes a supporting material comprising a head main body for applying a magnetic field to an information recording medium attached to one end with another end fixed, and a first elastic portion, which is capable of being elastically deformed, between the head main body and the fixed another end. A magnetic head hoisting and lowering member is disposed between the supporting material and the information recording medium and fixed in a manner capable of being brought into contact with and separating from the supporting material. A magnetic head holding member comprises a second elastic portion capable of being elastically deformed, being substantially in parallel with the surface of the information recording medium, having one end at the side of the second elastic portion being fixed, and disposed facing the surface at the opposite side to the information recording medium; and a posture holding member provided in the magnetic head holding member and protruding toward the side of the information recording medium so as to face the magnetic head hoisting and lowering member. In the magnetic head apparatus, the head main body is capable of moving between a first position in which the head main body approaches or is brought into contact with the information recording medium so as to record or reproduce information and a second position in which the head main body is far away from the information recording medium as compared with the first position, and in the first position, the posture holding portion is brought into contact with the magnetic head hosting and lowering member.

### BRIEF DESCRIPTION OF THE DRAWINGS

FIG. 1 is a plan view showing a magnetic head hoisting and lowering device according to a first embodiment of the present invention.

FIG. 2 is a plan view showing a main part of a magnetic head apparatus according to the first embodiment of the present invention.

FIG. 3 is a cross-sectional side view showing the magnetic head apparatus in the first position taken on line X-X according to the first embodiment of the present invention.

FIG. 4 is a cross-sectional side view showing the magnetic head apparatus in the second position taken on line X-X according to the first embodiment of the present invention.

FIG. 5 is a plan view showing a magnetic head hoisting and lowering device according to a second embodiment of the present invention.

FIG. 6 is a plan view showing a main part of a magnetic head apparatus according to a second embodiment of the present invention.

FIG. 7 is a cross-sectional side view showing the magnetic head apparatus in the first position taken on line X-X according to the second embodiment of the present invention.

FIG. 8 is a cross-sectional side view showing the magnetic head apparatus in the second position taken on line X-X according to the second embodiment of the present invention.

FIG. 9A is a cross-sectional side view showing a main part of the magnetic head apparatus in the first position taken on line X-X according to the second embodiment of the present invention.

FIG. 9B is a cross-sectional side view showing a main part of the magnetic head apparatus in the second position taken on line X-X according to the second embodiment of the present invention.

FIG. 10 is a plan view showing a magnetic head hoisting and lowering device according to a third embodiment of the present invention.

FIG. 11 is a plan view showing a main part of a magnetic head apparatus according to a third embodiment of the present invention.

FIG. 12 is a cross-sectional side view showing the magnetic head apparatus in the first position taken on line X-X according to the third embodiment of the present invention.

FIG. 13 is a cross-sectional side view showing the magnetic head apparatus in the second position taken on line X-X according to the third embodiment of the present invention.

FIG. 14A is a cross-sectional side view showing a main part of the magnetic head apparatus in the first position taken on line X-X according to the third embodiment of the present invention.

FIG. 14B is a cross-sectional side view showing a main part of the magnetic head apparatus in the second position taken on line X-X according to the third embodiment of the present invention.

FIG. 15 is a graph for calculating a stress of a magnetic head pressing elastic portion of the magnetic head apparatus according to the second embodiment of the present invention.

FIG. 16 is a graph for calculating a stress of a magnetic head pressing elastic portion of the magnetic head apparatus according to the third embodiment of the present invention.

FIG. 17 is a plan view showing a magnetic head hoisting and lowering device according to a fourth embodiment of the present invention.

FIG. 18 is a plan view showing a main part of a magnetic head apparatus according to a fourth embodiment of the present invention.

FIG. 19 is a cross-sectional side view showing the magnetic head apparatus in the first position taken on line X-X according to the fourth embodiment of the present invention.

FIG. 20 is a cross-sectional side view showing the magnetic head apparatus in the second position taken on line X-X according to the fourth embodiment of the present invention.

FIG. 21A is a cross-sectional side view showing a main part of the magnetic head apparatus in the first position taken on line X-X according to the fourth embodiment of the present invention.

FIG. 21B is a cross-sectional side view showing a main part of the magnetic head apparatus in the second position taken on line X-X according to the fourth embodiment of the present invention.

FIG. 22 is a plan view showing a magnetic head hoisting and lowering device according to a fifth embodiment of the present invention.

FIG. 23 is a plan view showing a main part of a magnetic head apparatus according to a fifth embodiment of the present invention.

FIG. 24 is a cross-sectional side view showing the magnetic head apparatus in the first position taken on line X-X according to the fifth embodiment of the present invention.

FIG. 25 is a cross-sectional side view showing the magnetic head apparatus in the second position taken on line X-X according to the fifth embodiment of the present invention.

FIG. 26A is a cross-sectional side view showing a main part of the magnetic head apparatus in the first position taken on line X-X according to the fifth embodiment of the present invention.

FIG. 26B is a cross-sectional side view showing a main part of the magnetic head apparatus in the second position taken on line X-X according to the fifth embodiment of the present invention.

FIG. 27 is a plan view showing a magnetic head hoisting and lowering device according to a sixth embodiment of the present invention.

FIG. 28 is a cross-sectional side view showing the magnetic head apparatus in the first position taken on line X-X according to the sixth embodiment of the present invention.

FIG. 29 is a cross-sectional side view showing the magnetic head apparatus in the second position taken on line X-X according to the sixth embodiment of the present invention.

FIG. 30A is a cross-sectional side view showing a main part of the magnetic head apparatus in the first position taken on line X-X according to the sixth embodiment of the present invention.

FIG. 30B is a cross-sectional side view showing a main part of the magnetic head apparatus in the second position taken on line X-X according to the sixth embodiment of the present invention.

FIG. 31 is a plan view showing a magnetic head hoisting and lowering device according to a seventh embodiment of the present invention.

FIG. 32 is a plan view showing a main part of a magnetic head apparatus according to a seventh embodiment of the present invention.

FIG. 33 is a cross-sectional side view showing the magnetic head apparatus in the first position taken on line X-X according to the seventh embodiment of the present invention.

FIG. 34 is a cross-sectional side view showing the magnetic head apparatus in the second position taken on line X-X according to the seventh embodiment of the present invention.

FIG. 35A is a cross-sectional side view showing a main part of the magnetic head apparatus in the first position taken on line X-X according to the seventh embodiment of the present invention.

FIG. 35B is a cross-sectional side view showing a main part of the magnetic head apparatus in the second position taken on line X-X according to the seventh embodiment of the present invention.

FIG. 36 is a plan view showing a magnetic head hoisting and lowering device according to an eight embodiment of the present invention.

FIG. 37 is a plan view showing a main part of a magnetic head apparatus according to an eighth embodiment of the present invention.

FIG. 38 is a cross-sectional side view showing the magnetic head apparatus in the first position taken on line X-X according to the eighth embodiment of the present invention.

FIG. 39 is a cross-sectional side view showing the magnetic head apparatus in the second position taken on line X-X according to the eighth embodiment of the present invention.

FIG. 40A is a cross-sectional side view showing a main part of the magnetic head apparatus in the first position taken on line X-X according to the eighth embodiment of the present invention.

FIG. 40B is a cross-sectional side view showing a main part of the magnetic head apparatus in the second position taken on line X-X according to the eighth embodiment of the present invention.

FIG. 40C is a cross-sectional side view showing a main part of the magnetic head apparatus in the third position taken on line X-X according to the eight embodiment of the present invention.

FIG. 41 is a plan view showing a magnetic head apparatus in the first position of the ninth embodiment of the present invention.

FIG. 42 is a plan view showing a magnetic head apparatus in the second position of the ninth embodiment of the present invention.

FIG. 43A is a cross-sectional side view showing a main part of the magnetic head apparatus in the first position taken on line X-X according to the ninth embodiment of the present invention.

FIG. 43B is a cross-sectional side view showing a main part of the magnetic head apparatus in the second position taken on line X-X according to the ninth embodiment of the present invention.

FIG. 43C is a cross-sectional side view showing a main part of the magnetic head apparatus in the third position taken on line X-X according to the ninth embodiment of the present invention.

FIG. 44 is a plan view showing a conventional magnetic head apparatus.

FIG. 45 is a cross-sectional side view showing a conventional magnetic head apparatus in the first position taken on line X-X.

FIG. 46 is a cross-sectional side view showing a conventional magnetic head apparatus in the second position taken on line X-X.

FIG. 47 is a cross-sectional side view showing a head main body of a conventional magnetic head apparatus.

### DESCRIPTION OF THE PREFERRED EMBODIMENTS

According to the first magnetic head apparatus of present invention, after the magnetic head pressing member and the elastic portion of the supporting material are brought into contact with each other, the head main body and supporting material move around the contact position as the center of the turning while the pressing portion of the magnetic pressing member presses the elastic portion toward the side of the information recording medium. Thus, the distance from the head main body to the center of rotation movement is reduced, and thus it is possible to reduce the moving amount of the magnetic head hoisting and lowering member, which is necessary to move the head main body to the second position. In addition, since the pressing portion presses the elastic portion, the hoisted amount of the supporting material can be suppressed, and thus the apparatus can be made thinner.

According to the second magnetic head apparatus of present invention, in the first position, since the posture holding member is brought into contact with the magnetic head hoisting and lowering member, the height of the tip of the magnetic head holding member in the first position becomes stable.

In the first magnetic head of the present invention, it is preferable that the magnetic head apparatus further includes: a magnetic head holding member substantially in parallel with the surface of the information recording medium, having one end fixed, and disposed facing a surface opposite side to the information recording medium in both faces of the supporting material, wherein the magnetic head pressing member is provided in the magnetic head holding member. According to this configuration, it is possible to place the magnetic head pressing member in the vicinity of the supporting material, thus miniaturizing the magnetic head pressing member and also miniaturizing the magnetic head apparatus.

Furthermore, it is preferable that the magnetic head pressing member is linked to the magnetic holding member via the magnetic head pressing elastic portion capable of being elastically deformed. According to this configuration, the magnetic head pressing elastic member can be self-supported in the first position, and thus a member for engaging the magnetic head pressing member is not necessary in the first position.

Furthermore, it is preferable that the magnetic head pressing elastic portion is configured by a plurality of plate springs disposed substantially in parallel with each other in the longitudinal direction of the supporting material. According to this configuration, it is possible to reduce the internal stress of the magnetic head pressing elastic portion at the time of turning the magnetic head pressing member, thus improving the reliability.

Furthermore, it is preferable that in the second position, in both ends in the longitudinal direction of the supporting material of the magnetic head pressing member, one end moves in the direction of going away from the information recording medium and is in contact with the supporting material, and another end moves in the direction of approaching the information recording medium and is in contact with the elastic portion of the supporting material. According to this configuration, a hosting and lowering member that is used specifically for the magnetic head pressing member is not required, thus enabling the number of components to be reduced.

Furthermore, it is preferable that in the second position, in both ends in the longitudinal direction of the supporting material of the magnetic head pressing member, one end moves in the direction of going away from the information recording medium and is in contact with the magnetic head hoisting and lowering member, and another end moves in the direction of approaching the information recording medium and is in contact with the elastic portion of the supporting material. According to this configuration, the amount of moving of the magnetic head pressing member becomes stable, thus enabling the supporting material elastic portion to be elastically deformed more reliably.

Furthermore, it is preferable that a supporting material hole portion is provided between the supporting material elastic portion of the supporting material and the head main body, and one end of the magnetic head pressing member is brought into contact with the magnetic head hoisting and lowering member by penetrating one end of the magnetic head pressing member through the supporting material hole portion. According to this configuration, it is possible to follow larger wobbling of the information recording medium.

In the second magnetic head apparatus of the present invention, it is preferable that at least one of the posture holding portion and the magnetic head hoisting and lowering member comprises a flat surface portion that is substantially in parallel with the surface of the information recording medium, and in the first position, the flat surface portion is brought into contact with the posture holding portion or the magnetic head hoisting and lowering member. According to this configuration, even if a location error between the magnetic head hoisting and lowering member and the magnetic head holding member occurs, since the height of the tip of the magnetic head holding member is not changed, it is possible to increase the error tolerance in the dimensions of each component.

Furthermore, it is preferable that the magnetic head hoisting and lowering member turns around an axis as a center, which is substantially in parallel with the surface of the information recording medium and substantially perpendicular to the longitudinal direction of the supporting material, and in the first position, at the side closer to the end at which the magnetic head holding member is fixed with respect to the center, the posture holding portion is brought into contact with the magnetic head hoisting and lowering member. According to this configuration, in the second position, the height of the tip of the magnetic head holding member can be lowered, thus enabling the apparatus to be thin.

Furthermore, it is preferable that the magnetic head holding member is provided with a magnetic head pressing member. While the head main body moves from the first position to the second position, one end of the magnetic head pressing member is brought into contact with the supporting material or the magnetic head hoisting and lowering member and moves in the direction of going away from the information recording medium, another end of the magnetic head pressing member approaches the supporting material and is brought into contact with the first elastic portion so as to elastically deform the first elastic portion toward the side of the information recording medium in the second position, and in the second position, the posture holding portion is separated from the magnetic head hoisting and lowering member. According to this configuration, it is possible to bring one end of the magnetic head pressing member into contact with the magnetic head hoisting and lowering member reliably.

Furthermore, it is preferable that the magnetic head hoisting and lowering member is provided with an evacuation portion in which a concave portion which is concave toward the side of the information recording medium or a through hole or a notch is formed. When the information recording medium is tilted so as to make the position in which the information recording medium is attached/detached be a third position, and in the third position, the posture holding portion is evacuated in the evacuation portion. According to this configuration, it is possible to reduce the amount of deformation of the magnetic head holding elastic portion in the third position and to reduce the internal stress of the magnetic head holding elastic portion, thus improving the reliability of the apparatus.

Furthermore, it is preferable that while the head main body moves from the first position to the second position, the magnetic head hoisting and lowering member moves in the longitudinal direction of the supporting material and the posture holding portion and the magnetic head hoisting and lowering member are separated from each other. According to this configuration, it is possible to separate the magnetic head main body from the information recording medium reliably, thus improving the reliability of the apparatus.

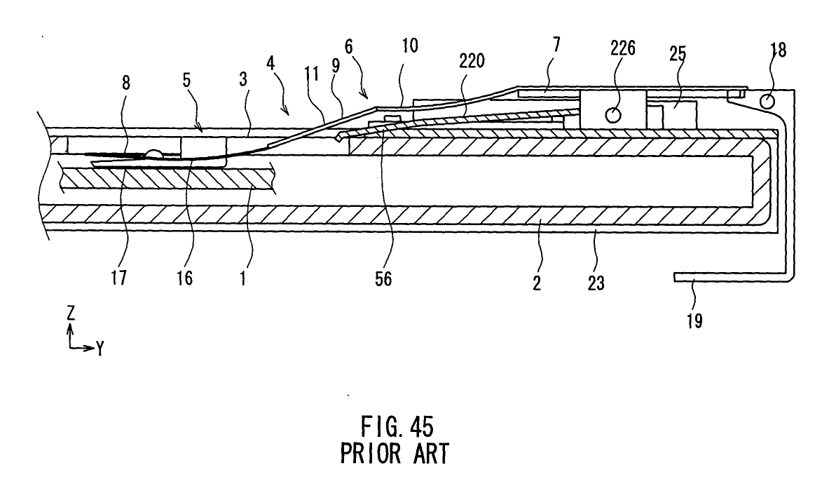

Hereinafter, embodiments of the present invention will be explained with reference to drawings. Note here that the components having the same functions as those described in the conventional example shown in FIGS. 44 to 47 are given the same reference numbers and duplicate explanations therefor are omitted.

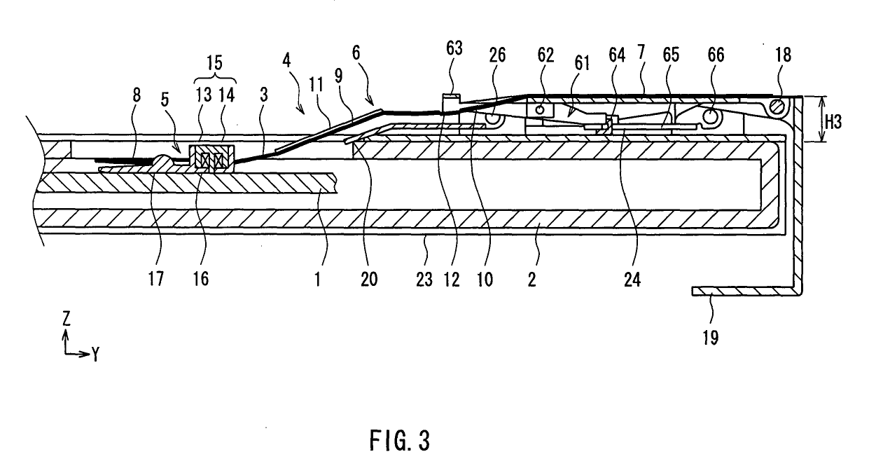

Furthermore, in the following explanation, a first position denotes a position in which a head main body (reference numeral 5 in an example of FIG. 3) approaches or is brought into contact with an information recording medium (reference numeral 1 in an example of FIG. 3) so as to record or reproduce information; and the second position denotes a position in which the head main body is far away from the information recording medium as compared with the first position.

(First Embodiment)

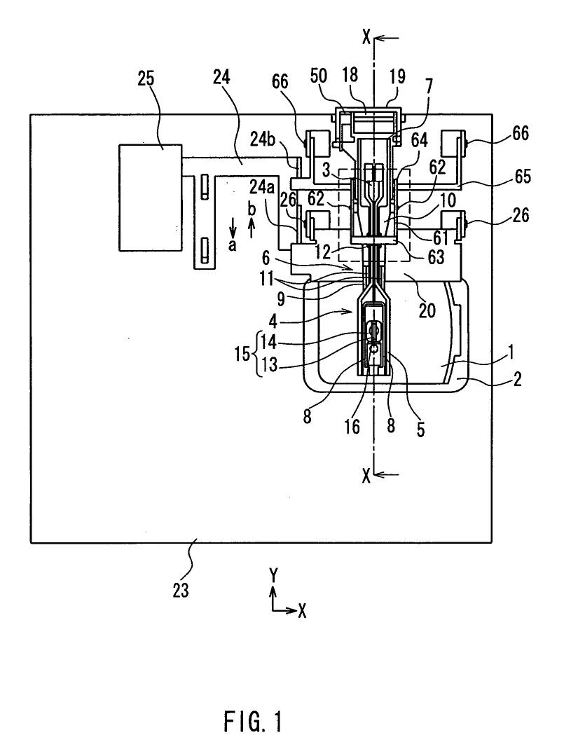

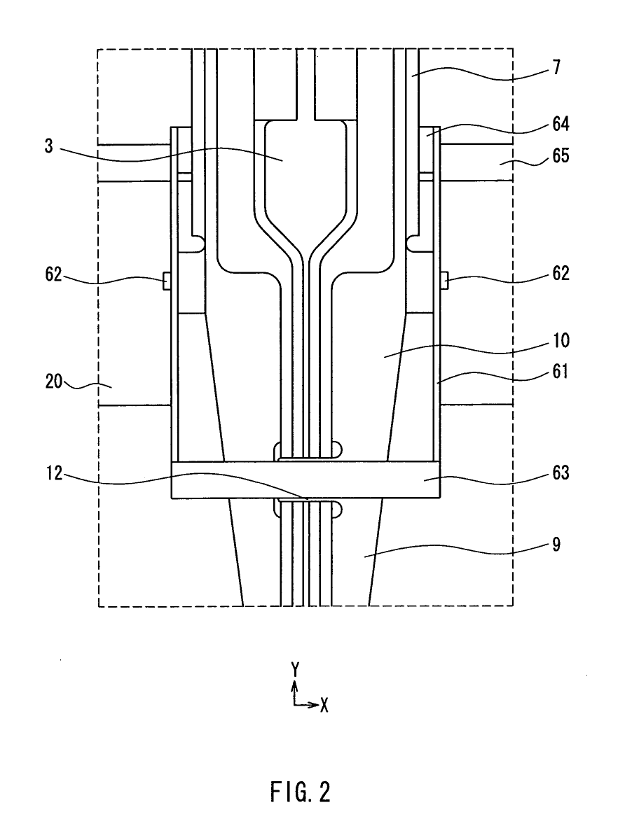

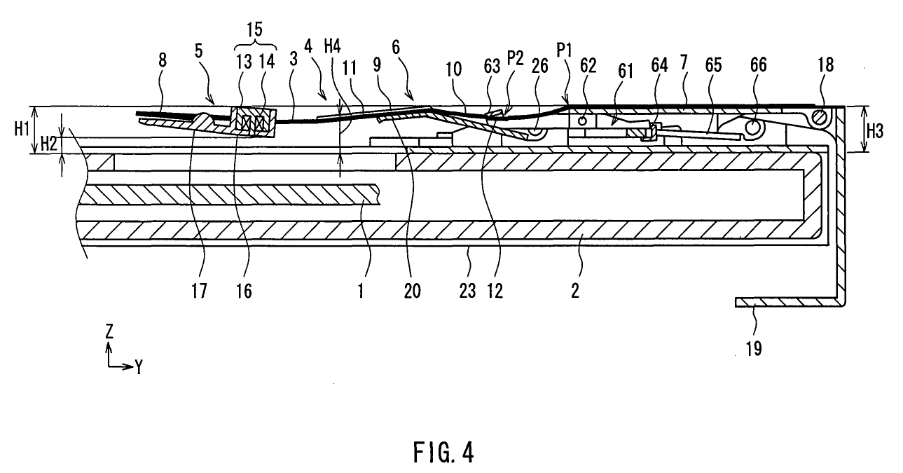

FIG. 1 is a plan view showing a magnetic head apparatus according to a first embodiment of the present invention; FIG. 2 is a plan view showing a main part of the magnetic head apparatus of FIG. 1; FIG. 3 is a cross-sectional side view showing the magnetic head apparatus in the first position taken on line X-X in FIG. 1; and FIG. 4 is a cross-sectional side view showing the magnetic head apparatus in the second position taken on line X-X in FIG. 1.

In FIGS. 1 to 4, reference numeral 6 denotes a supporting material made of a thin spring material, for example, SUS304, BeCu, or the like. In this embodiment, the supporting material 6 is fixed to a fixing material 7 at one end. In this example, the supporting material 6 includes a first spring system 10 that is an elastic portion capable of being elastically deformed, an interchange portion 9 that is a rigid substance and a second spring system 8 that is a second elastic portion capable of being elastically deformed.

The first spring system 10 follows the wobbling of the magneto-optical disk 1 that is an information recording medium and applies the entire load. The interchange portion 9 extends from the first spring member 10 by tilting at a predetermined angle so as to prevent the interference with respect to a cartridge 2 and includes a drawing rib 11, for example, formed by extrusion so as to form a rigid substance. The second spring system 8 extends from the interchange portion 9 at a predetermined angle with respect to the interchange portion 9 and follows the wobbling and surface shape of the magneto-optical disk 1.

The fixing material 7, which is made of a metal plate, for example, iron, stainless steel, etc. fixes one end of the supporting member 6. Furthermore, the fixing material 7 is attached to a linking member 19 via a shaft 18 capable of turning and is biased to the side of the magneto-optical disk 1 by a spring 50. The linking member 19 links the magnetic head 4 with the optical head, and the optical head is placed facing the magnetic head 4 with the magneto-optical disk 1 sandwiched therebetween.

As shown in, for example, FIG. 47, the head main body 5 is produced as follows. A magnetic head element 15 is formed by attaching a wound coil 14 to a central magnetic pole of an E-shaped magnetic core 13 made of a soft magnetic substance such as ferrite, etc. An open end of the E-shaped magnetic core 13 is placed facing the magneto-optical disk 1, and this magnetic head element 15 is integrated into a sliding body 16 made of a resin having an excellent sliding property, for example, polyphenylene sulfide, liquid crystal polymer, etc.

Reference numeral 17 denotes a sliding portion. The sliding portion 17 is integrated into the surface of the sliding body 16 facing the magneto-optical disk 1 and formed so as to have an arc-shaped cross section (that is, a cross section in the direction perpendicular to the loaded magneto-optical disk 1) and thus, it is always brought into point contact with the magneto-optical disk 1 and a smooth contact sliding is carried out.

Reference numeral 3 is a flexible printed board provided with wiring for transmitting a modulated signal to the head main body, and it is attached to the supporting material 6, for example, with a double-faced tape (not shown). Then, one end of the flexible printed board 3 is soldered to the both ends of a lead wire of the coil 14, and another end is connected to the driving circuit (not shown) of the magnetic head.

The head main body 5 is fixed by fusing or adhesion or is integrated by resin integration molding into the side of the swinging end of the supporting material 6. Furthermore, the supporting material 6 is fixed to the fixing material 7 by laser spot welding or electric welding, etc. at one end thereof (end portion at the side of the fixing material 7).

Reference numeral 61 denotes a magnetic head pressing member. The magnetic head pressing member 61 is made of, for example, stainless steel, iron, resin, etc. and is attached to the fixing material 7 and capable of turning via a magnetic head pressing turning axis 62. The magnetic head pressing member 61 has a pressing portion 63 located on the upper surface of the first spring system 10 at one end and a moving portion 64 engaged in a magnetic head pressing hoisting and lowering mechanism 65 at another end. Since the pressing portion 63 is located in the upper portion of the first spring system 10, it is placed facing the surface opposite to the magneto-optical disk 1 in the both faces of the supporting material 6.

The magnetic head pressing hoisting and lowering mechanism 65 is made of, for example, stainless steel, iron, resin, or the like, and attached to a holder 23 for holding the cartridge 2 in a manner capable of turning via a hoisting and lowering turning axis 66.

Reference numeral 20 denotes a magnetic head hoisting and lowering member. The magnetic head hoisting and lowering member 20 is made of, for example, stainless steel, iron, resin, or the like, and attached to a holder 23 for holding the cartridge 2 in a manner capable of turning via the hoisting and lowering turning axis 26

Reference numeral 24 is a slide member. The slide member 24 is made of, for example, stainless steel, iron, resin, or the like, and attached to the holder 23 in a manner in which it can move in the y-direction (the longitudinal direction of the supporting material 6) with respect to the holder 23 and moves by a hoisting and lowering driving portion 25 composed of a motor, gear, etc. The sliding member 24 and the magnetic head hoisting and lowering member 20 are brought into contact with each other via a cam mechanism 24a, and the sliding member 24 and the magnetic head pressing hoisting and lowering mechanism 65 are brought into contact with each other via a cam mechanism 24b.

When the sliding member 24 moves in the direction shown by an arrow a of FIG. 1, the magnetic head hoisting and lowering member 20 is lifted by the cam mechanism 24a, so that it turns in a clockwise direction from the state shown in FIG. 3 and approaches from the lower side of the supporting material 6 to the supporting material 6. When this turning movement advances, as shown in FIG. 4, the magnetic head hoisting and lowering member 20 presses the supporting material 6 from the lower side.

At the same time, the magnetic head pressing hoisting and lowering mechanism 65 is lifted by a cam mechanism 24b and turns in a clockwise direction around a turning axis 66 from the state shown in FIG. 3. Thus, the magnetic head pressing hoisting and lowering mechanism 65 lifts up the magnetic head pressing member 61 and the magnetic head pressing member 61 turns in a counter-clockwise direction around the magnetic head pressing turning axis 62. With this turning movement, the pressing portion 63 approaches the first spring system 10 from the upper side, so that the pressing portion 63 presses the first spring system 10 as shown in FIG. 4.

That is, in the state shown in FIG. 4, the magnetic head hoisting and lowering member 20 presses the supporting material 6 from the lower part while the pressing portion 63 presses the first spring system 10 from the upper side.

Furthermore, when the sliding member 24 moves in the direction shown by an arrow b in FIG. 1, the magnetic head hoisting and lowering member 20 turns in a counter-clockwise direction from the state shown in FIG. 4 so as to be separated from the supporting material 6. Then, at the same time, also the magnetic head pressing hoisting and lowering mechanism 65 turns in a counter clockwise direction from the state shown in FIG. 4, so that the pressing portion 63 is separated from the first spring system 10 and the state shown in FIG. 3 is obtained.

In the first position (recording position) of the supporting material 6, as shown in FIG. 3, neither magnetic head hoisting and lowering member 20 nor magnetic head pressing member 61 is in contact with the supporting material 6. They are spaced with respect to the magnetic head 4.

In the first position, a portion which protrudes most or farthest away from the upper surface of the cartridge 2 is a fixing material 7, and the thickness of the magnetic head 4 is defined by a height H3 from the upper surface of the cartridge 2 to the upper surface of the fixing material 7.

As mentioned above, in the movement of the supporting material 6 from the first position to the second position (reproducing position), as shown in FIG. 3, while the magnetic head hoisting and lowering member 20 turns in a clockwise direction around the hoisting and lowering turning axis 26, the magnetic head hoisting and lowering member 20 is brought into contact with the interchange portion 9 and pushes up the supporting material 6 and the head main body 5 so as to be separated from the magneto-optical disk 1. At the same time, the magnetic head pressing portion 61 turns in a counter-clockwise direction and the pressing portion 63 is brought into contact with the first spring system 10.

Thus, the center of turning movement for separating the head main body 5 from the magneto-optical disk 1 moves from the end portion (P1) at the side of the fixing material 7 of the first spring member 10 to the proximity of the central portion (P2) in the longitudinal direction of the first spring system 10 as shown in FIG. 4.

Furthermore, with the turning movement of the magnetic head hoisting and lowering member 20 and the magnetic head pressing member 61, the first spring system 10 is elastically deformed (curved) by the pressure of the pressing portion 63 and at the same time, the interchange portion 9 is lifted by the magnetic head hoisting and lowering member 20, thus holding the magnetic head 4 in the second position for securing space H2 between the head main body 5 and the cartridge 2.

In this way, in this embodiment, the center of turning movement of the supporting material 6 moves from P1 to P2, so that the distance between the center of turning movement of the supporting material 6 and the position where the supporting material 6 and the magnetic head hoisting and lowering material 20 are brought into contact with each other is reduced. In addition, by the pressure of the magnetic head pressing member 61, the first spring system 10 is positively elastically deformed toward the side of the cartridge 2.

Thus, in this embodiment, while reducing the height H4 of the lifted magnetic head hoisting and lowering member 20 (FIG. 4) as compared with that of a conventional example as shown in FIG. 4, it is possible to secure the space H2 between the head main body 5 and the cartridge 2. Therefore, it is possible to make the magneto-optical recording and reproducing apparatus thinner.

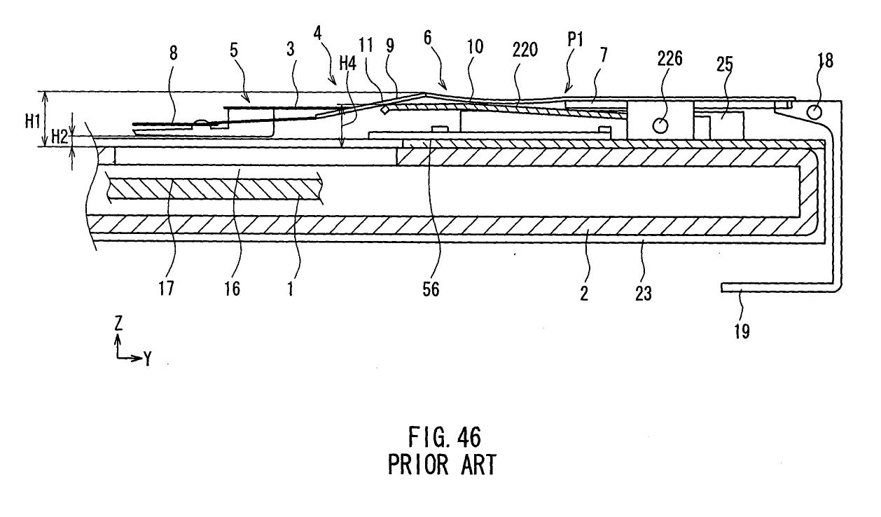

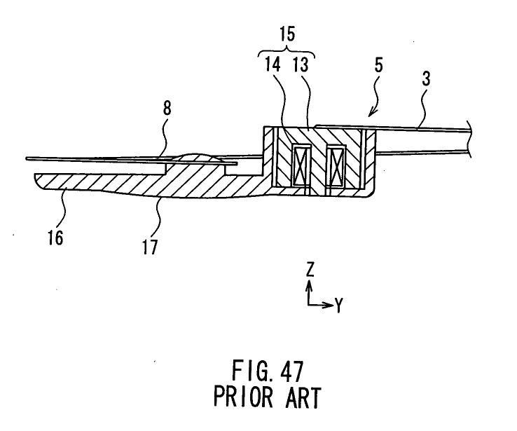

Comparing FIG. 4 of this embodiment with FIG. 46 of a conventional example, the maximum height H1 to the supporting material 6 from the cartridge 2 is larger than the height H3 of the fixing member 7 in FIG. 46 of the conventional example. On the other hand, in FIG. 4 of the embodiment, H1 is suppressed to the same height as that of the fixing member 7.

Furthermore, since the magnetic head pressing member 61 is attached to the fixing material 7, it can move together with the supporting material 6 formed of a thin plate in the direction of the radius of the magneto-optical disk 1. Therefore, the supporting material 6 is not plastically deformed, and the reliability of the magnetic head apparatus can be improved.

Note here that, in the embodiment, the magnetic head hoisting and lowering member 20 is turned so as to be brought into contact with the supporting material 6. However, the same effect can be obtained by sliding the magnetic head hoisting and lowering member 20 in the x-direction shown in FIGS. 1 to 3 so as to be brought into contact with the supporting material 6.

Furthermore, in the embodiment, the magnetic head 4 including the first spring system 10, the interchange 9 and the second spring system 8 was explained. However, needless to say, the same effect can be obtained by the configuration in which the supporting material 6 includes the first spring system and the interchange portion, and the head main body 5 is fixed to a tip of the interchange portion.

Furthermore, in the embodiment, the magneto-optical disk apparatus was explained. However, needless to say, the same effect can be obtained also in the magnetic disk apparatus represented by a floppy disk apparatus, which is also the same as in the following embodiments. In this case, in the first position, not only recording but also reproduction is carried out and in the second position, the magnetic head is clear of the disk

(Second Embodiment)

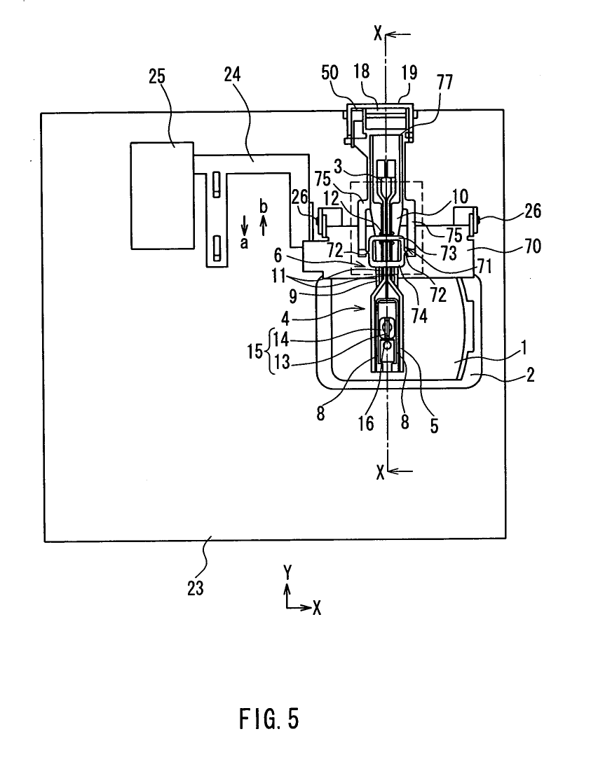

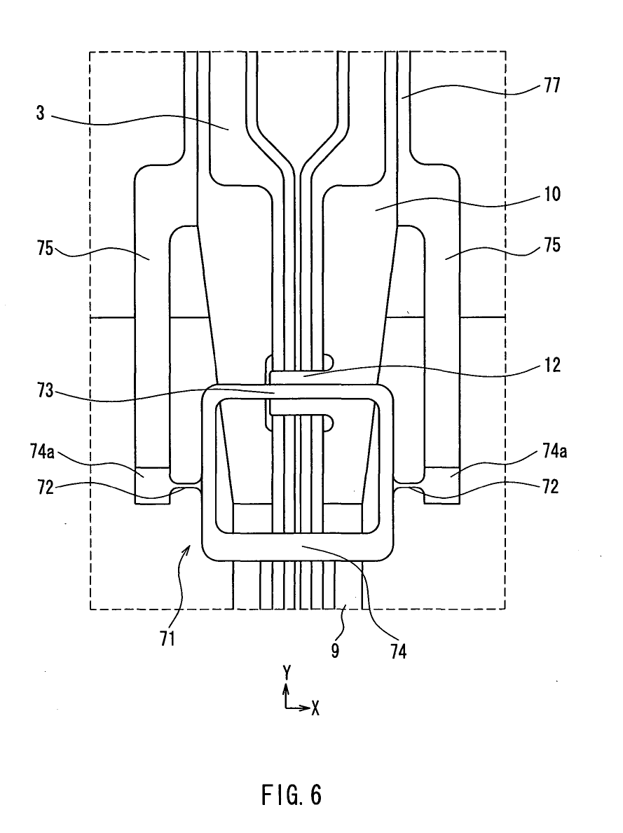

Hereinafter, a magnetic head apparatus according to the second embodiment will be explained with reference to FIGS. 5 to 9. FIG. 5 is a plan view showing a magnetic head apparatus according to a second embodiment of the present invention; and FIG. 6 is a plan view showing a main part of the magnetic head apparatus of FIG. 5.

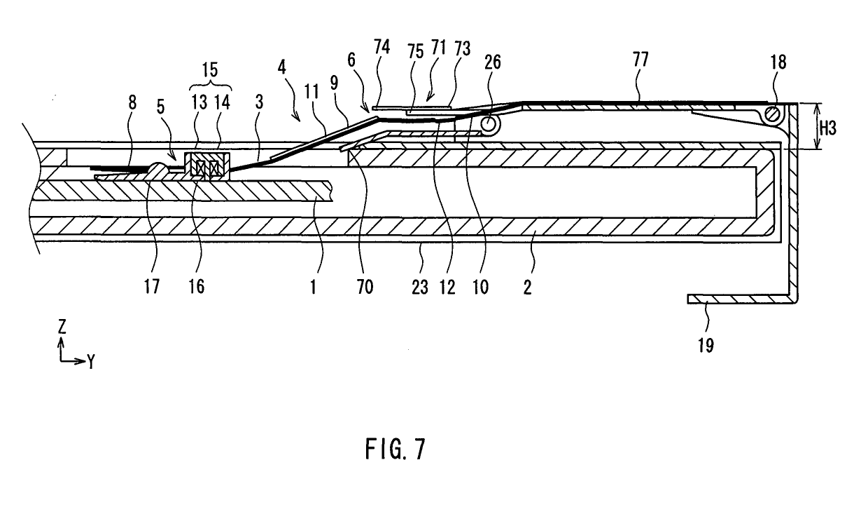

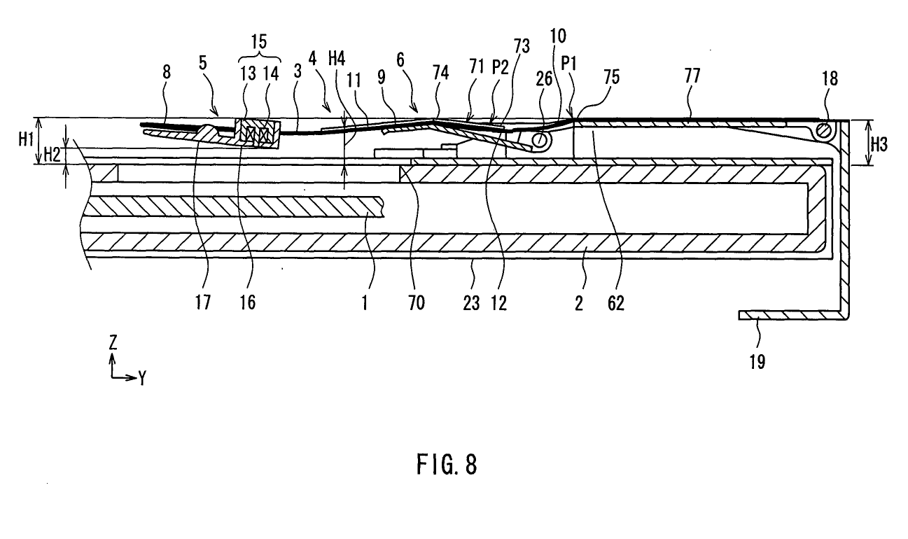

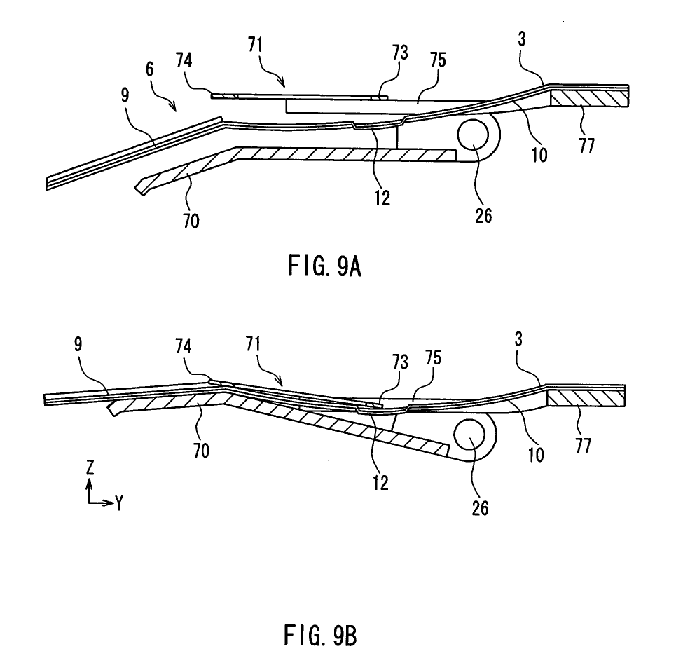

FIG. 7 is a cross-sectional side view showing the magnetic head apparatus in the first position taken on line X-X in FIG. 5; and FIG. 8 is a cross-sectional side view showing the magnetic head apparatus in the second position taken on line X-X in FIG. 5. FIG. 9A is a cross-sectional side view showing a main part of the magnetic head apparatus in the first position taken on line X-X in FIG. 5; and FIG. 9B is a cross-sectional side view showing a main part of the magnetic head apparatus in the second position taken on line X-X in FIG. 5.

As shown in FIGS. 5 and 6, in the magnetic head apparatus according to the second embodiment, a magnetic head holding member 75 extends from the fixing material 77 to the side of the head main body 5 substantially in parallel with the magneto-optical disk 1. At the side of the head main body 5 of the magnetic head holding member 75, a magnetic head pressing member 71 is placed.

To the magnetic head pressing member 71, a hinge shaped magnetic head pressing elastic portion 72 having a function of torsion is integrated. To the outside of the magnetic head pressing elastic portion 72, both end portions 74a having a larger width than that of the magnetic head pressing elastic portion 72 are provided. The both end portions 74a are jointed into the magnetic head holding member 75 by laser spot welding or electric welding, and thereby the magnetic head pressing member 71 is fixed to the fixing material 77 via the magnetic head holding member 75.

An example in which the magnetic head pressing member 71 attached to the magnetic head holding member 75 via the magnetic head pressing elastic part 72 has a voided square shape in this embodiment and has a portion (pressing portion 73) that is brought into contact with the first spring system 10 at the reproducing time and a portion (moving portion 74) that is brought into contact with the interchange portion 9 will be explained.

In the first position of the supporting material 6, as shown in FIG. 9A, both the magnetic head hoisting and lowering member 70 and the magnetic head pressing member 71 are placed so that they are not brought into contact with the supporting material 6. In the movement from the first position to the second position, the magnetic head hoisting and lowering member 70 turns in a clockwise direction around the hoisting and lowering turning axis 26 from the state shown in FIG. 9A.

With this turning movement, the magnetic head hoisting and lowering member 70 moves (is lifted) in the direction in which the magnetic head hoisting and lowering member 70 separates from the magneto-optical disk 1 so as to be brought into contact with the interchange portion 9. When the magnetic head hoisting and lowering member 70 is lifted further, the interchange portion 9 approaches and is brought into contact with the moving portion 74 of the magnetic head pressing member 71. When the magnetic head hoisting and lowering member 70 is further lifted, the magnetic head pressing member 71 turns in a clockwise direction from the state shown in FIG. 9A to the state shown in FIG. 9B.

More specifically, when the pressing portion 73 approaches (goes down to) the magneto-optical disk 1 and is brought into contact with the first spring system 10, and the magnetic head hoisting and lowering member 70 is lifted further, force is applied to the moving portion 74.

Thus, the hinge-shaped magnetic head pressing elastic portion 72 is elastically deformed by torsion, the pressing portion 71 is tilted and the pressing portion 73 goes down so as to be brought into contact with the first spring system 10. Therefore, by elastically deforming the first spring system 10 more positively, space H2 (FIG. 8) between the head main body 5 and the cartridge 2 is secured and the magnetic head is held in the second position.

That is, similar to the first embodiment, it is possible to secure the space H2 while reducing the height H1 (FIG. 8) and to make the magneto-optical recording and reproducing apparatus thinner.

Furthermore, in this embodiment, since the magnetic head pressing member 71 is fixed to the magnetic holding member 75 with a fixing material 77 extended, the magnetic head pressing member 71 is not required to be extended to the fixing member 77 for fixing the magnetic head pressing member 71, thus enabling the magnetic head pressing member 71 to be miniaturized. Furthermore, as shown in FIG. 9A, by displacing the magnetic head holding member 75 to the lower side (at the side of the disk 1) as compared with the position of the fixing member 77, it is also possible to lower the position of the magnetic head pressing member 71 in the height direction, thus enabling magnetic head apparatus to be miniaturized.

Then, by lifting up the interchange portion 9 that is in contact with the moving portion 74 by the use of the magnetic head hoisting and lowering member 70, the magnetic head pressing member 71 turns. Therefore, it is possible to eliminate a special-purpose magnetic head pressing hoisting and lowering mechanism as in the first embodiment.

Furthermore, by attaching the magnetic head pressing member 71 to the magnetic head holding member 75 via the magnetic head pressing elastic portion 72, in the first position of the magnetic head 4, the magnetic head pressing member 71 is self-supported and thus reliably secures the space with respect to the supporting material 6 in the first position. Therefore, a member for engaging the magnetic head pressing member 71 in the first position can be eliminated to reduce the number of components.

(Third Embodiment)

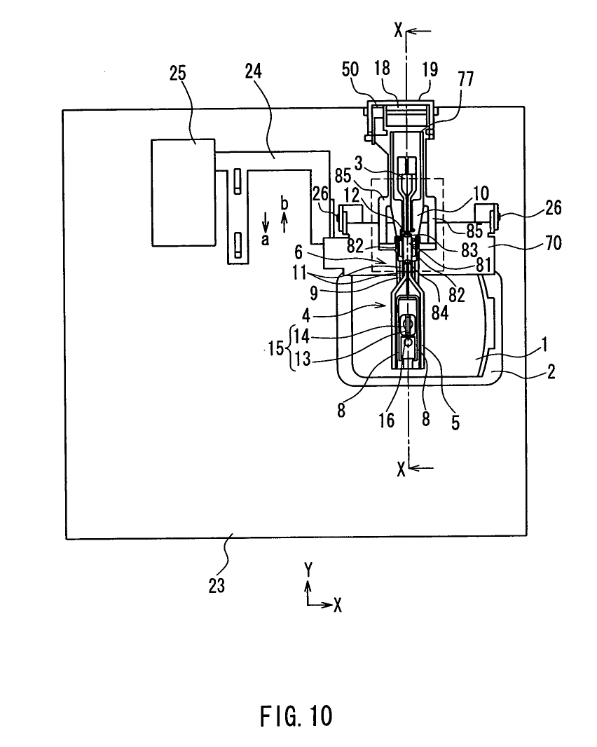

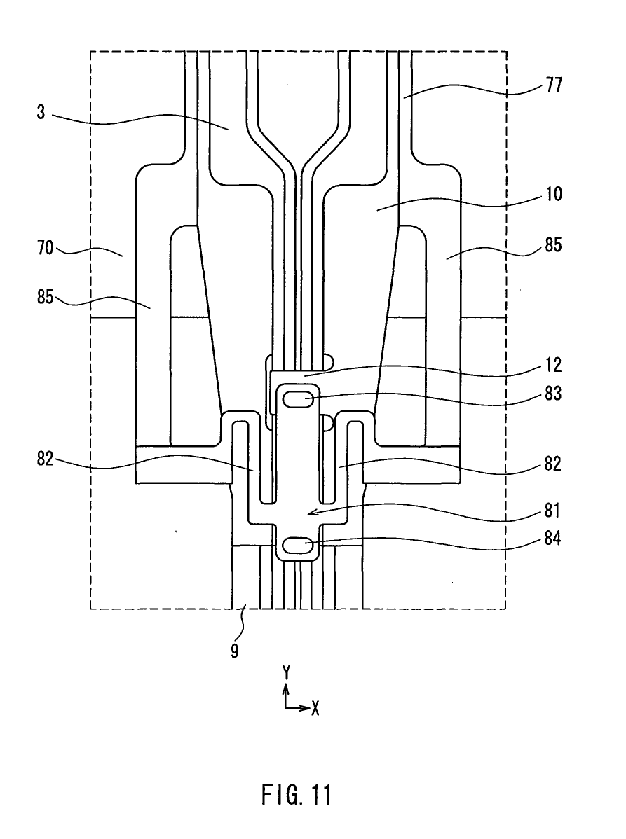

Hereinafter, a magnetic head apparatus according to the third embodiment will be explained with reference to FIGS. 10 to 14. FIG. 10 is a plan view showing a magnetic head apparatus according to a third embodiment of the present invention. FIG. 11 is a plan view showing a main part of the magnetic head apparatus of FIG. 10.

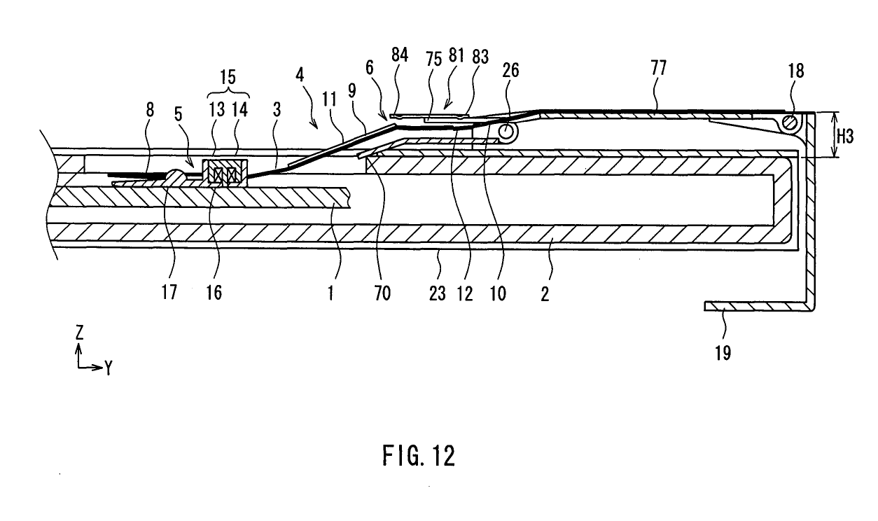

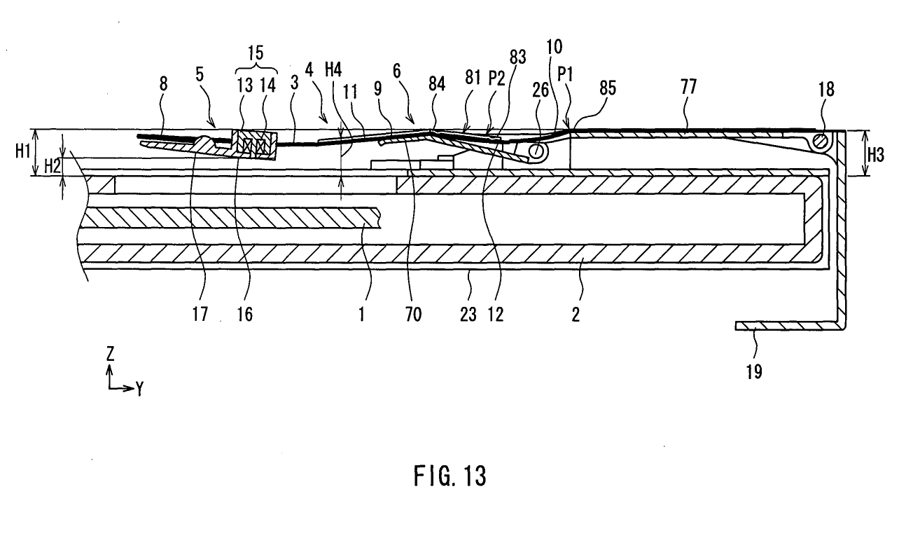

FIG. 12 is a cross-sectional side view showing the magnetic head apparatus in the first position taken on line X-X in FIG. 10; and FIG. 13 is a cross-sectional side view showing the magnetic head apparatus in the second position taken on line X-X in FIG. 10.

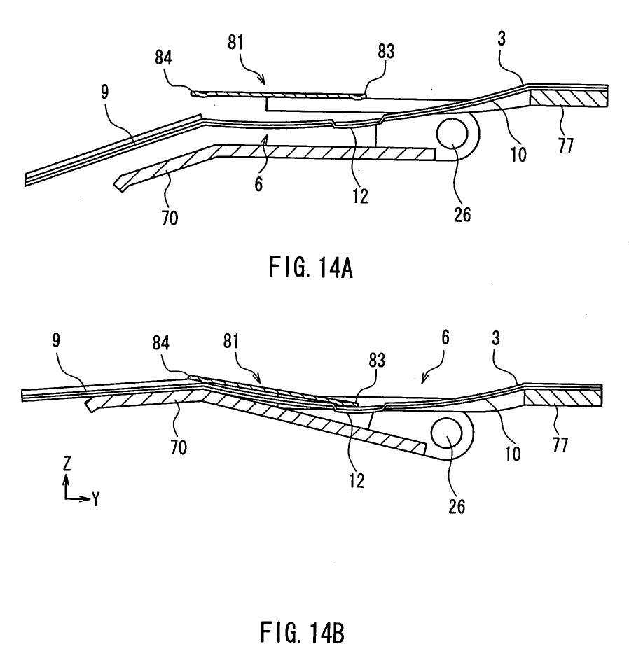

FIG. 14A is a cross-sectional side view showing a main part of the magnetic head apparatus in the first position taken on line X-X in FIG. 10; and FIG. 14B is a cross-sectional side view showing a main part of the magnetic head apparatus in the second position taken on line X-X in FIG. 10.

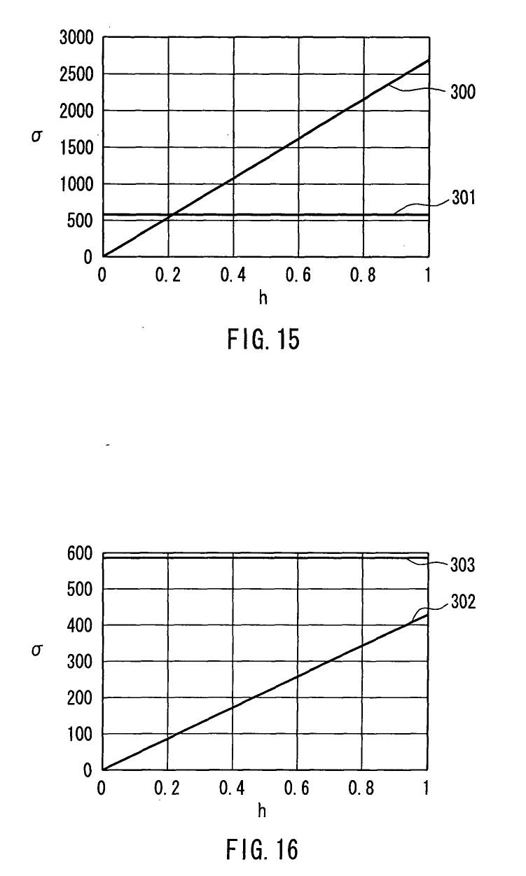

FIG. 15 is a graph showing a stress in the case where the magnetic head pressing elastic portion is formed of a hinge shaped spring; and FIG. 16 is a graph showing a stress of a magnetic head pressing elastic portion according to this embodiment.

The magnetic head apparatus according to the third embodiment is characterized in that a magnetic head pressing elastic portion 82 does not have a hinge shape unlike the second embodiment but is formed of two plate springs that are substantially in parallel with the loaded magneto-optical disk 1 and in parallel with the longitudinal direction of the supporting material 6.

The third embodiment is different from the second embodiment in the configuration of the magnetic head pressing elastic portion but is the same in the basic configuration and operations and effects. The difference between the third embodiment and the second embodiment will be explained.

The magnetic head pressing elastic member 82 is made of stainless steel, phosphor bronze, plastic, or the like, and is integrated into the magnetic head pressing member 81. The end of the magnetic head pressing elastic member 82 is fixed to the magnetic head holding member 85 by laser spot welding, electric welding, or the like.

In general, the supporting material 6 is made of stainless steel, phosphor bronze, or the like, having a thickness of about 0.04 mm to 0.08 mm. Since the magnetic head pressing member 81 elastically deforms the first spring system 10 in the second position, the plate thickness should be larger than that of the supporting material 6.

Furthermore, the magnetic pressing member 81 of this embodiment needs to move in the z-direction at the pressing portion 83 in the range from 0.2 mm to 1 mm. Therefore it is necessary to suppress the increase in the stress generated by the increase of the displacement.

According to the hinge-shaped magnetic head pressing elastic portion 82 as in the second embodiment, although the structure can be simplified, the increase in the stress generated by the increase in the displacement is increased. This is shown in FIG. 15.

FIG. 15 is a graph showing the relationship between the displacement and stress in the hinge-shaped magnetic head pressing elastic portion 82 as shown in FIG. 6. The horizontal axis h (mm) shows the displacement of the pressing portion 73 and the vertical axis σ (N/mm²) shows the stress generated in the magnetic head pressing elastic portion 72.

A line 300 shows the relationship between the displacement h and the stress σ; and a line 301 shows the spring limit value of SUS301-EH (588 N/mm²) that is a material used for the magnetic head pressing elastic portion 82. The size of the magnetic head pressing elastic portion 72 is 0.1 mm in the plate thickness and 0.1 mm in the minimum width of the hinge portion in the y-direction.

As shown in FIG. 15, when h is 0.2 mm, the value of stress reaches the spring limit value. In the case of this embodiment, the size is necessary to be set within the range in which the displacement h of the pressing portion 73 is not beyond 0.2 mm.

On the other hand, in the magnetic head pressing elastic portion 82 shown in the embodiment, since a plate spring is used, the effective length of the spring can be increased, and thus it is possible to suppress the increase in the stress with respect to the displacement of the pressing portion 83.

FIG. 16 is a graph showing the relationship between the displacement and the stress in the configuration of the plate spring as shown in FIG. 11. The horizontal axis h (mm) shows the displacement of the pressing portion 83 and the vertical axis σ (N/mm²) shows the stress generated in the magnetic head pressing elastic portion 82.

A line 302 shows the relationship between the displacement h and the stress σ, and a line 303 shows the spring limit value of SUS301-EH (588 N/mm²) that is a material used for the magnetic head pressing elastic portion 82. The size of the magnetic head pressing elastic portion 82 is 0.1 mm in the plate thickness, 0.3 mm in the width of the spring in the x-direction, and 7 mm in the effective length of spring.

As is apparent from FIG. 16, even in the case of h=1 mm, the stress is lower than the spring limit value of the material. Therefore, in this embodiment, even if the displacement h of the pressing portion 73 is increased, the generated stress can be minimized, thus enabling the reliability of the magnetic head apparatus to be improved.

Note here that the example of using two parallel plate springs was explained. However, three or more parallel plate springs may be used.

(Fourth Embodiment)

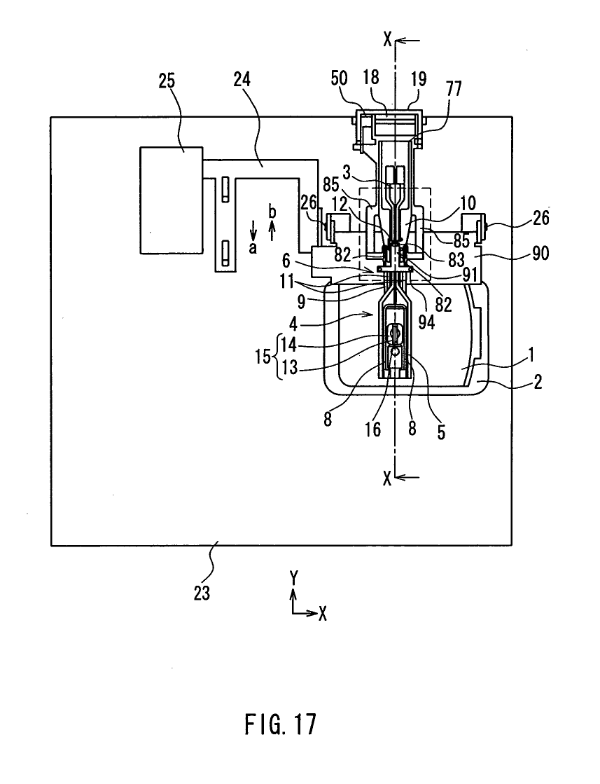

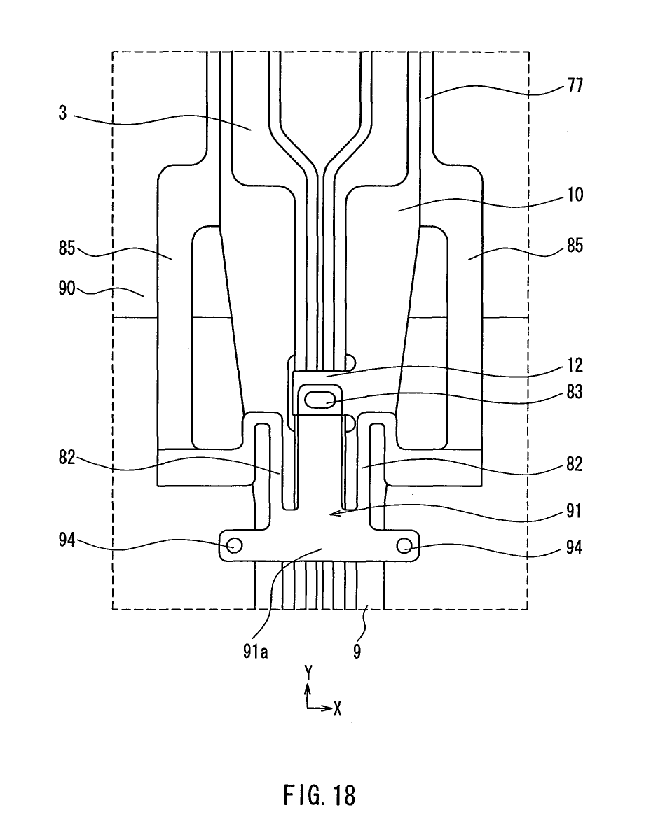

Hereinafter, a magnetic head apparatus according to the fourth embodiment will be explained with reference to FIGS. 17 to 21. FIG. 17 is a plan view showing a magnetic head apparatus according to a fourth embodiment of the present invention; and FIG. 18 is a plan view showing a main part of the magnetic head apparatus shown in FIG. 17.

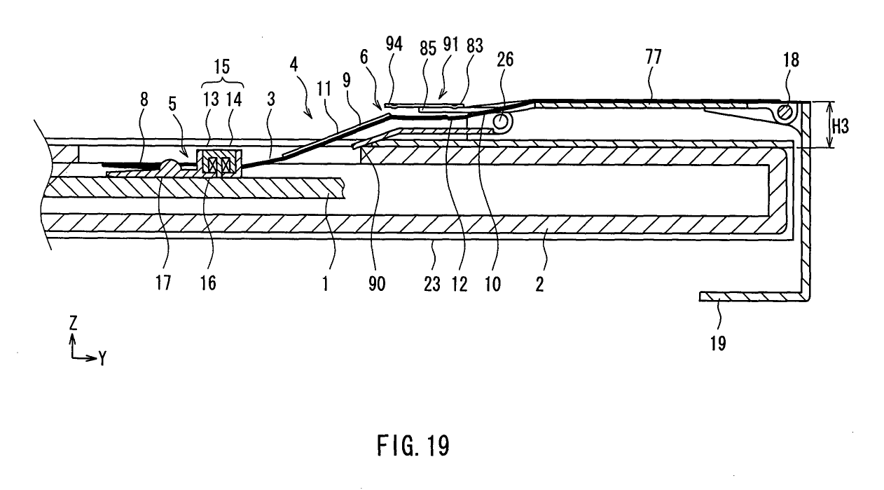

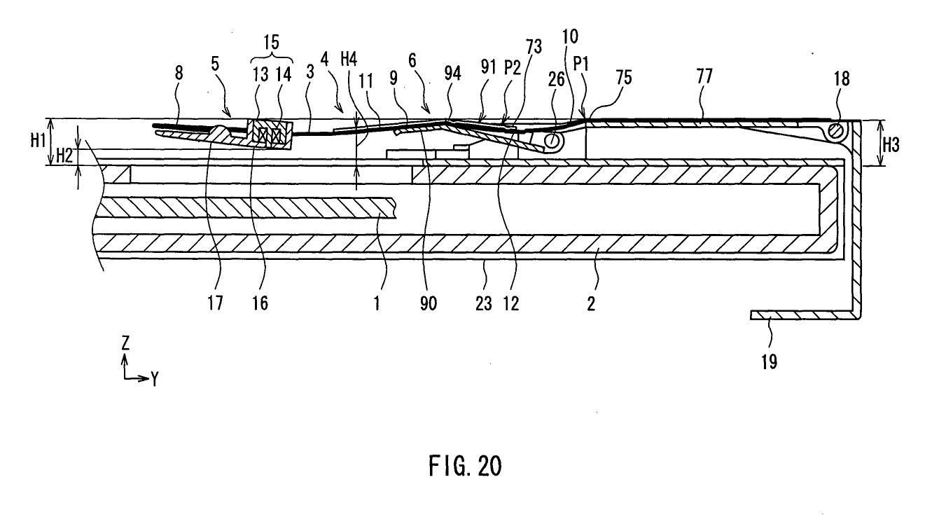

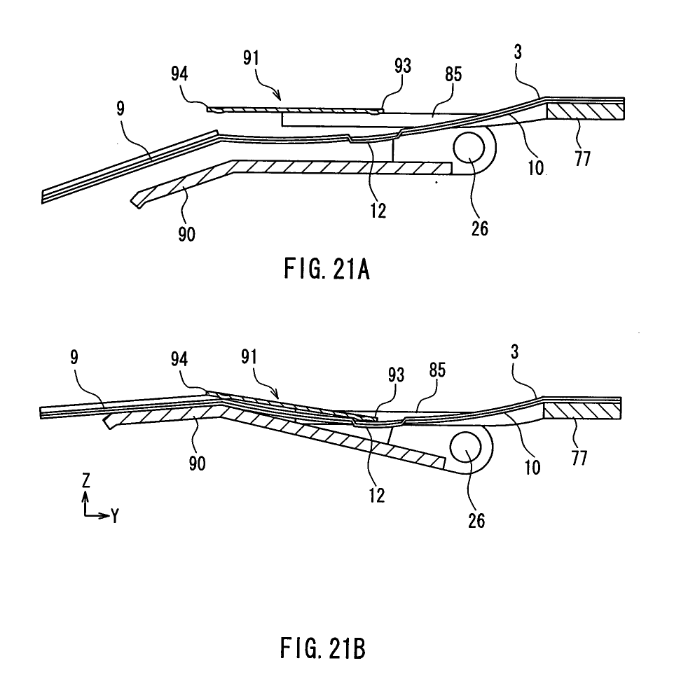

FIG. 19 is a cross-sectional side view showing the magnetic head apparatus in the first position taken on line X-X shown in FIG. 17; and FIG. 20 is a cross-sectional side view showing the magnetic head apparatus in the second position taken on line X-X in FIG. 17. FIG. 21A is a cross-sectional side view showing a main part of the magnetic head apparatus in the first position taken on line X-X in FIG. 17; and FIG. 21B is a cross-sectional side view showing a main part of the magnetic head apparatus in the second position taken on line X-X in FIG. 17.

The magnetic head apparatus according to the fourth embodiment is characterized in that in the movement from the first position to the second position, the moving portion 94 is brought into contact with the magnetic head hoisting and lowering member 90 so as to turn on the magnetic head pressing member 91.

The fourth embodiment is different from the second and third embodiments in the configuration of the magnetic head pressing elastic portion but is the same as the second and third embodiments in the basic configuration and operations and effects. The difference between the fourth embodiment and the second and third embodiments will be explained.

As shown in FIG. 18, the tip end 91a of the magnetic head pressing member 91 extends in the x-direction and the width thereof in the x-direction becomes larger than the width of the interchange portion 9 of the supporting member 6. Both end portions 91a are provided with a moving portion 94 and the moving portion 94 forms a protruding portion that is convex toward the side of the magnetic head hoisting and lowering member 90.

In the movement from the first position (FIGS. 19 and 21A) to the second position (FIGS. 20 and 21B), the magnetic head hoisting and lowering member 90 turns in a clockwise direction and the magnetic head hoisting and lowering member 90 is brought into contact with the moving portion 94 and is kept in contact with it also in the second position.

As mentioned above, the moving portion 94 is formed at both ends in a way in which it avoids the supporting material 6. Therefore, as shown in FIGS. 20 and 21B, even if the magnetic head hoisting and lowering member 90 is brought into contact with the supporting material 6, the moving portion 94 is brought into direct contact with the magnetic head hoisting and lowering member 90, and the moving portion 94 is not brought into contact with the supporting material 6.

The magnetic head hoisting and lowering member 90 is generally made of stainless steel, iron, and the like, having a thickness of about 0.3 mm to 0.6 mm and has more sufficient rigidity as compared with the supporting material 6. Thus, the position accuracy of the position of the moving portion 94 in the second position is particularly improved as compared with the configuration in which the moving portion 94 is brought into direct contact with the supporting material 6.

(Fifth Embodiment)

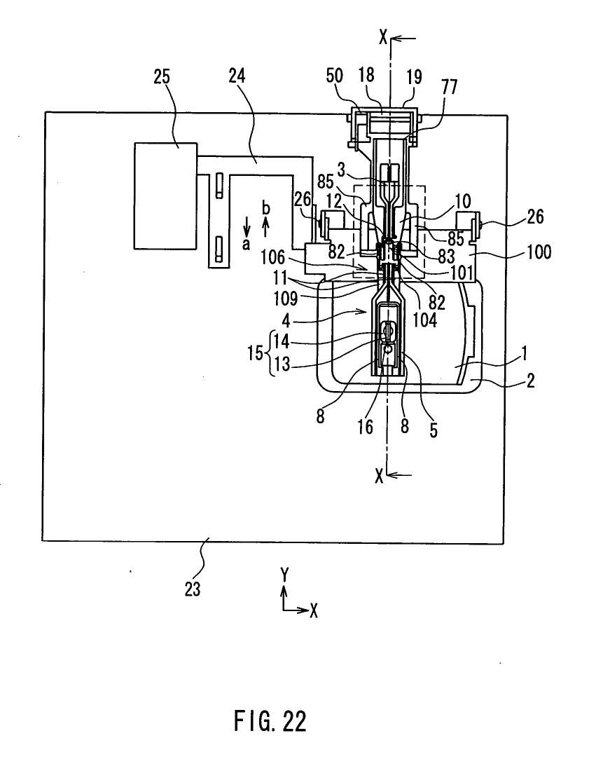

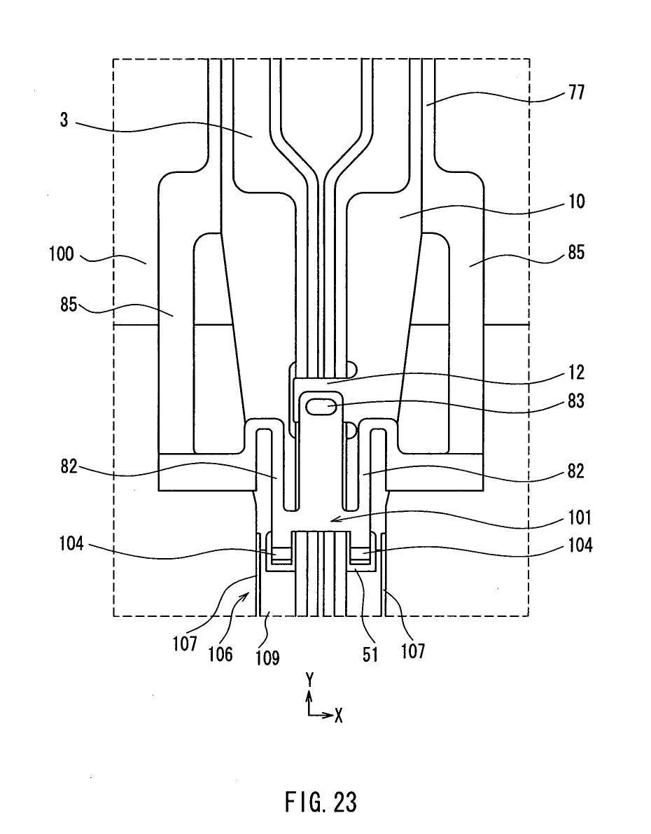

Hereinafter, a magnetic head apparatus according to the fifth embodiment will be explained with reference to FIGS. 22 to 26. FIG. 22 is a plan view showing a magnetic head apparatus according to a fifth embodiment of the present invention; and FIG. 23 is a plan view showing a main part of the magnetic head apparatus shown in FIG. 22.

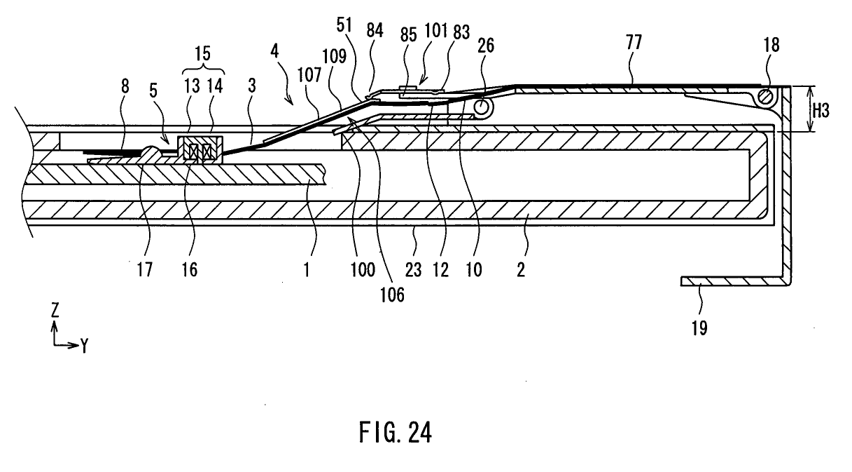

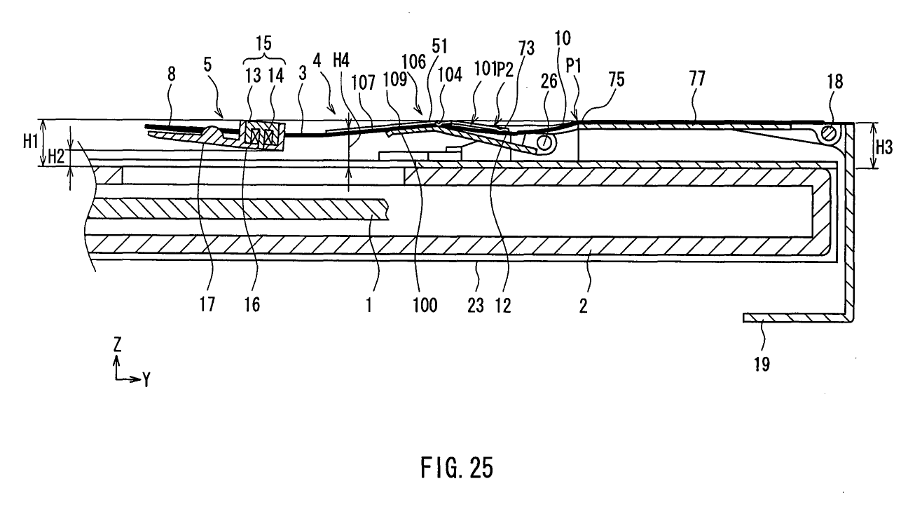

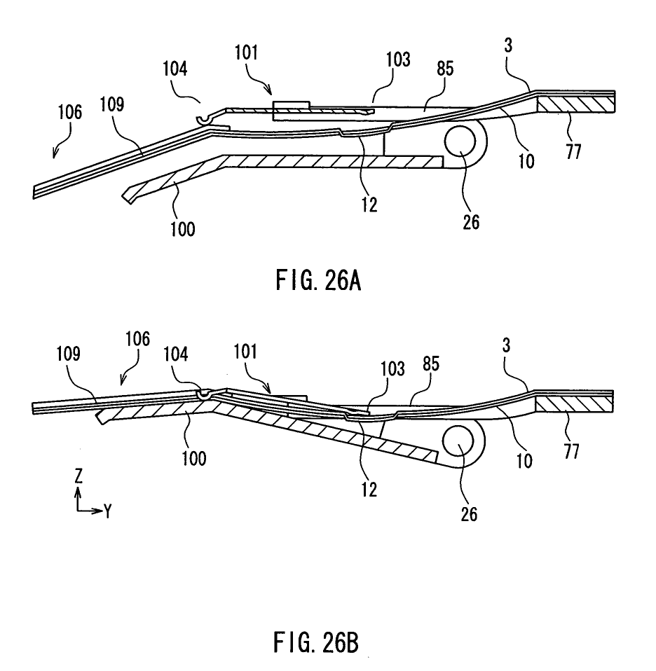

FIG. 24 is a cross-sectional side view showing the magnetic head apparatus in the first position taken on line X-X in FIG. 22; and FIG. 25 is a cross-sectional side view showing the magnetic head apparatus in the second position taken on line X-X in FIG. 22. FIG. 26A is a cross-sectional side view showing a main part of the magnetic head apparatus in the first position taken on line X-X in FIG. 22; and FIG. 26B is a cross-sectional side view showing a main part of the magnetic head apparatus in the second position taken on line X-X in FIG. 22.

The magnetic head apparatus according to the fifth embodiment is characterized in that a supporting material hole portion 51 is provided in the proximity of the interchange portion 109 of the supporting material 106 and that in the movement from the first position to the second position, the moving portion 104 penetrates into the supporting material hole portion 51 and is brought into contact with the magnetic head hoisting and lowering member 100 so as to turn on the magnetic head pressing member 101.

The fifth embodiment is different from the fourth embodiment in the configuration of the magnetic head pressing elastic portion but is the same as the fourth embodiment in the basic configuration and operations and effects. The difference between the fifth embodiment and the fourth embodiment will be explained.

As shown in FIGS. 23 and 24, the supporting material 106 forms the interchange portion 109 as a rigid substance by providing standing walls 107 at both sides in the x-direction between the first spring system 10 and the second spring system 8. The interchange portion 109 is provided with a supporting material hole portion 51 and the magnetic head pressing member 101 is placed so that the moving portion 104 is located on the upper portion of the supporting material hole portion 51.

In the first position (FIGS. 24 and 26A), in order to allow the head main body 5 to follow the wobbling of the magneto-optical disk 1, the supporting material 106 moves upward/downward in the z-direction. Even if the interchange portion 109 moves in the direction of going away from the magneto-optical disk 1, the moving portion 104 enters the supporting material hole portion 51 to be evacuated, and thus the movement of the supporting material 106 is not hindered. Therefore, the head main body 5 can follow larger wobbling of the magneto-optical disk 1.

Furthermore, in the movement from the first position to the second position (FIGS. 25 and 26B), the moving portion 104 is brought into contact with the magnetic head hoisting and lowering member 100 via the supporting material hole portion 51.

(Sixth Embodiment)

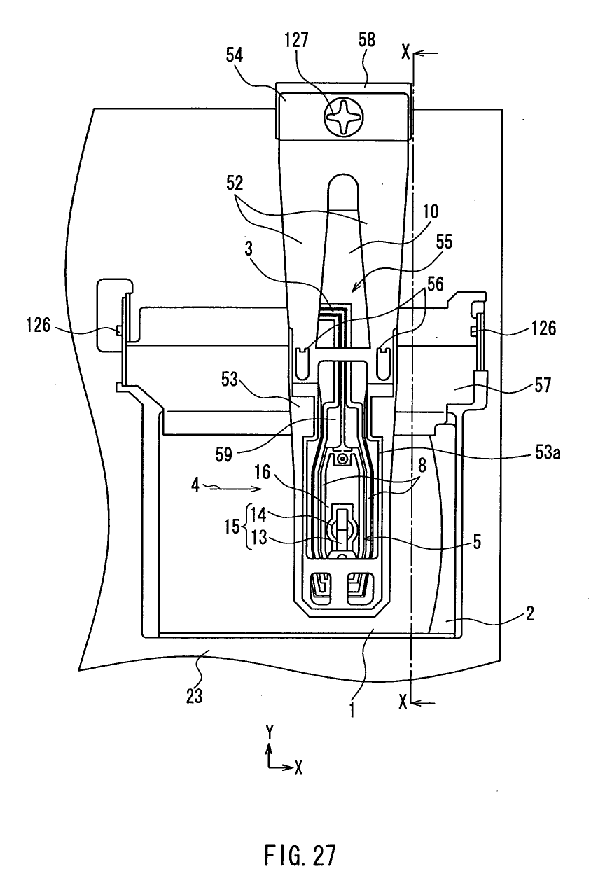

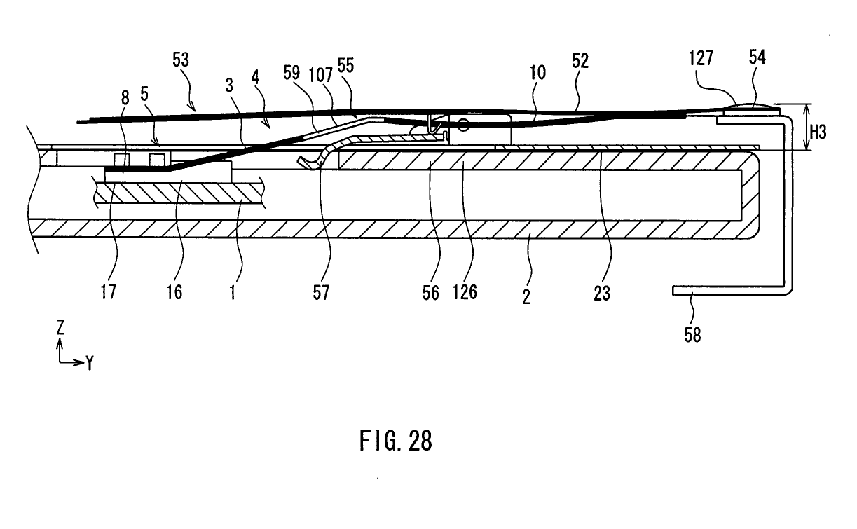

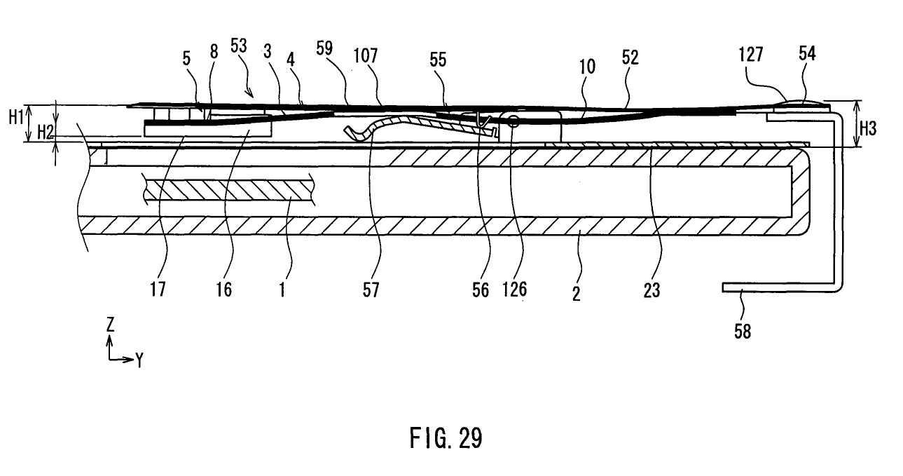

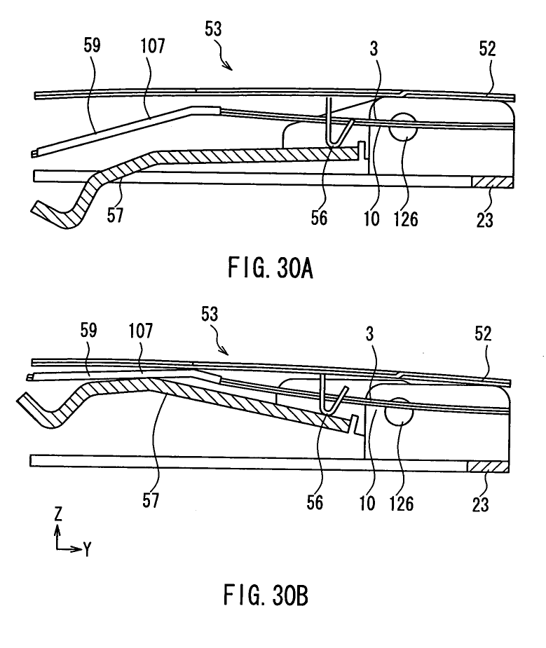

Hereinafter, a magnetic head apparatus according to the sixth embodiment will be explained with reference to FIGS. 27 to 30. FIG. 27 is a plan view showing a magnetic head apparatus according to a sixth embodiment of the present invention; FIG. 28 is a plan view showing a cross-sectional side view showing the magnetic head apparatus in the first position taken on line X-X in FIG. 27; and FIG. 29 is a cross-sectional side view showing the magnetic head apparatus in the first position taken on line X-X in FIG. 27. FIG. 30A is a cross-sectional side view showing a main part of the magnetic head apparatus in the first position taken on line X-X in FIG. 27; and FIG. 30B is a cross-sectional side view showing a main part of the magnetic head apparatus in the second position taken on line X-X in FIG. 27.

The magnetic head apparatus according to the sixth embodiment is characterized in that a magnetic head holding elastic body 52 is provided between a fixing material 54 and a magnetic head holding member 53 and a posture holding portion 56, which protrudes toward the side of the magneto-optical disk 1 in the z-direction around the middle portion of the magnetic head holding member 53, is provided. In the first position, the posture holding portion 56 is brought into contact with the magnetic head hoisting and lowering member 57.

The magnetic head holding member 53, magnetic head holding elastic portion 52, the fixing material 54 and the posture holding member 56 may be integrated into each other and made of stainless steel, phosphor bronze, or the like, having a thickness of about 0.05 mm to 0.2 mm.

The supporting material 54 holds one end of the supporting material 55 by laser spot welding, electric welding, or the like, so as to be fixed to the linking member 58 by a screw 127.

The magnetic head holding member 53 becomes a rigid substance by a drawing 53a, and extends to the upper part of the head main body 5 in the y-direction.

As shown in FIGS. 28 and 30A, in the first position, the posture holding portion 56 is brought into contact with the magnetic head hoisting and lowering member 57. With this configuration, the magnetic head holding elastic portion 52 applies pressure to the magnetic head hoisting and lowering member 57 in the direction to the magneto-optical disk 1.

In the movement of the head main body 5 from the first position (FIGS. 28 and 30A) to the second position (FIGS. 29 and 30B), the magnetic head hoisting and lowering member 57 turns in a clockwise direction and is brought into contact with the interchange portion 59, then the magnetic head hoisting and lowering member 57 further turns in a clockwise direction around a turning axis 126. Thereby, the head main body 5 is separated from the magneto-optical disk 1. When the head main body 5 moves in the direction of approaching the second position, the head main body 5 is brought into contact with the magnetic head holding member 53 in a state in which the tip of the head main body 5 tilts so that it separates away from the magneto-optical disk 1.

Then, when the interchange portion 59 is lifted by the magnetic head hoisting and lowering member 57, as shown in FIG. 29, the head main body 5 takes a horizontal posture following the magnetic head holding member 53.

As mentioned above, according to the magnetic head apparatus of the sixth embodiment, the magnetic head holding elastic portion 52 is provided between the fixing material 54 and the magnetic head holding member 53; and a posture holding portion 56, which protrudes toward the side of the magneto-optical disk 1 in the z-direction around the middle portion of the magnetic head holding member 53, is provided. Since the posture holding portion 56 is brought into contact with the magnetic head hoisting and lowering member 57 in the first position, a spring for biasing the linking member 58 is not necessary, thus enabling the number of components to be reduced.

Furthermore, as shown in FIG. 29, since the head main body 5 is brought into contact with the magnetic head holding member 53 in the second position, it is possible to regulate the position of the head main body horizontally, thus enabling the magnetic head apparatus to be thin.

(Seventh Embodiment)

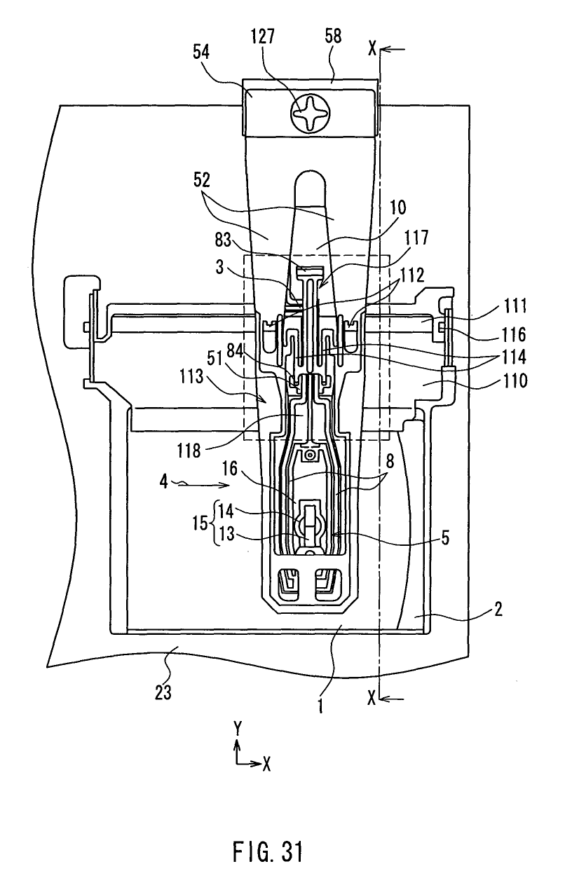

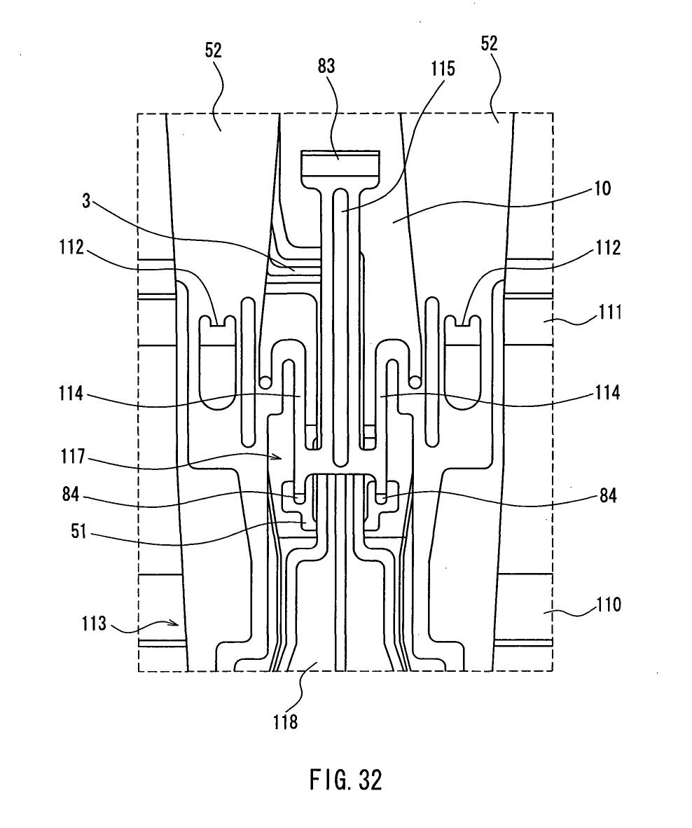

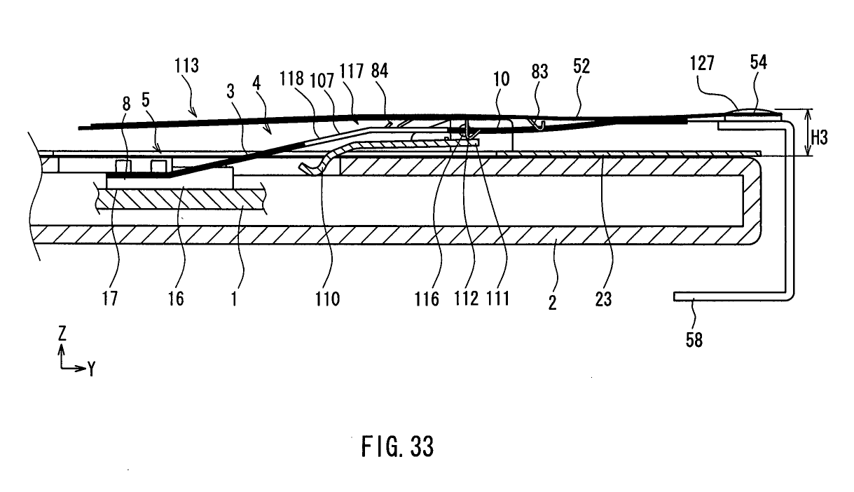

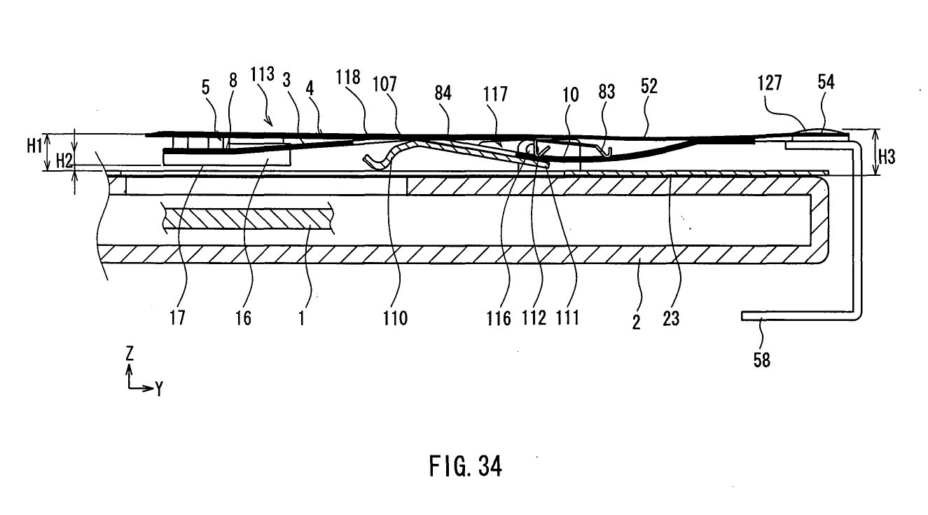

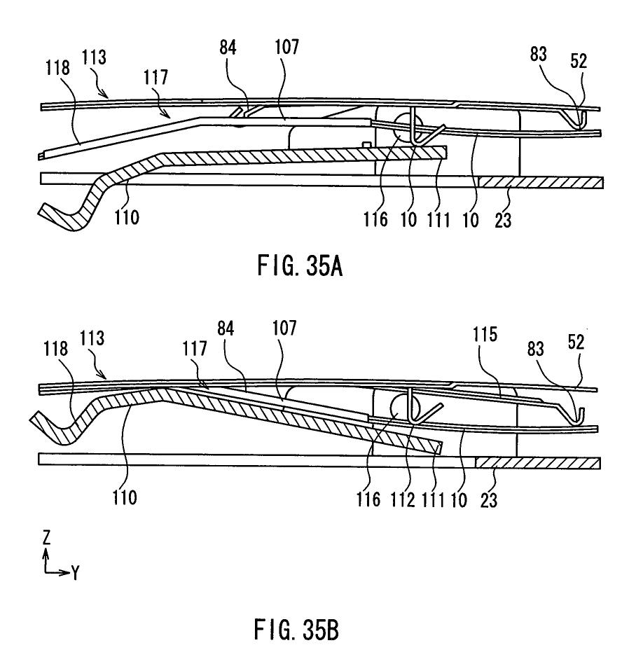

Hereinafter, a magnetic head apparatus according to the seventh embodiment will be explained with reference to FIGS. 31 to 35. FIG. 31 is a plan view showing a magnetic head apparatus according to a seventh embodiment of the present invention; and FIG. 32 is a plan view showing a main part of the magnetic head apparatus shown in FIG. 31. FIG. 33 is a cross-sectional side view showing the magnetic head apparatus in the first position taken on line X-X in FIG. 31; and FIG. 34 is a cross-sectional side view showing the magnetic head apparatus in the first position taken on line X-X in FIG. 31. FIG. 35A is a cross-sectional side view showing a main part of the magnetic head apparatus in the first position taken on line X-X in FIG. 31 and FIG. 35B is a cross-sectional side view showing a main part of the magnetic head apparatus in the second position taken on line X-X in FIG. 31.

The magnetic head apparatus according to the seventh embodiment is characterized in that a magnetic head hoisting and lowering member 110 is provided with a flat surface portion 111, which is substantially in parallel with the magneto-optical disk 1 in the first position, on the side being closer to the fixing material 54 with respect to the center of the magnetic head hoisting and lowering turning axis 116, and the posture holding member 112 is brought into contact with the flat surface portion 111 in the first position.

Furthermore, the magnetic head apparatus according to the seventh embodiment is characterized in that the magnetic head holding member 113 is integrated into the magnetic head pressing elastic member 114 and the magnetic head pressing member 115.

In the magnetic head hoisting and lowering member 110, a surface portion 111 that is substantially in parallel with the magneto-optical disk in the first position is provided at the side closer to the fixing member 54 with respect to the center of the magnetic head hoisting and lowering turning axis 116. As shown in FIGS. 31 and 32, the magnetic head holding member 113 is integrated into the magnetic head pressing elastic portion 114 and the magnetic head pressing member 115. As shown in FIGS. 33 and 35A, in the first position, the posture holding portion 112 is brought into contact with the flat surface portion 111 and placed with space between the magnetic head pressing member 115 and the supporting material 117.

In the case where the head main body 5 moves from the first position to the second position, the magnetic head hoisting and lowering member 110 turns in a clockwise direction around the magnetic head hoisting and lowering turning axis 116 and is brought into contact with the interchange 118 as shown in FIGS. 34 and 35B. At this time, a flat surface portion 111 moves toward the side of the magneto-optical disk 1 and is separated from the posture holding member 112. This is because the portion in which the flat surface portion 111 is brought into contact with the posture holding portion 112 is located at the side closer to the fixing material 54 than the center of the magnetic head hoisting and lowering turning axis 116, so that with the turning movement of the magnetic head hoisting and lowering material 110 in a clockwise direction, the flat surface portion 111 moves away from the posture holding portion 112.

When the magnetic head hoisting and lowering member 110 turns further, in the magnetic head hoisting and lowering member 110, in the longitudinal direction of the supporting material 117, the portion opposite to the flat surface portion 111 is brought into contact with the moving portion 84 so as to allow the magnetic head pressing member 115 to turn in a clockwise direction. Thus, the pressing portion 83 is brought into contact with the first spring system 10 and is elastically deformed.

At this time, since the posture holding portion 112 is separated from the magnetic head hoisting and lowering member 110, the biasing force by the magnetic head pressing portion 114 can be transmitted sufficiently to the magnetic head pressing portion 115.

This is because the state is changed from a state in which the biasing force of the magnetic head holding elastic portion 52 is applied to the magnetic head hoisting and lowering member 110 via the posture holding portion 112 to a state in which the biasing force of the magnetic head holding elastic portion 52 is applied to the magnetic head hoisting and lowering member 110 via the moving portion 84.

Thus, the tip portion of the magnetic head holding member 113 in the second position does not move toward the side separating from the magneto-optical disk 1 in the z-direction, and thereby the height of the magnetic head in the second position at the time of reproduction can be reduced, thus enabling the magneto-optical disk recording and reproducing apparatus to be thin.

Note here that in the configuration of this embodiment, the magnetic head hoisting and lowering member 110 is provided with the flat surface portion 111 so that the posture holding member 112 and the flat surface portion 111 are brought into contact with each other in the first position. However, the configuration is not necessarily limited to this. For example, a configuration in which the flat surface portion is provided in at least one of the posture holding member 112 and the magnetic head hoisting and lowering member 110, and in the first position, either the posture holding member 112 or the magnetic head hoisting and lowering member 110 is brought into contact with the flat surface portion, may be employed.

(Eighth Embodiment)

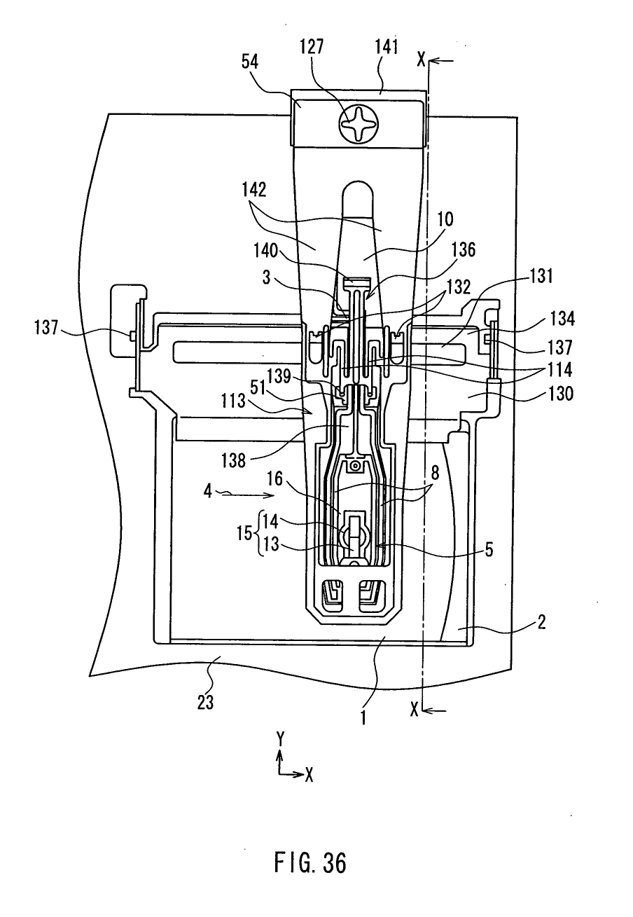

Hereinafter, a magnetic head apparatus according to the eighth embodiment will be explained with reference to FIGS. 36 to 40. In the following explanation, a third position means a position in which a magneto-optical disk 1 that is an information recording medium and cartridge 2 are attached/detached to/from the magneto-optical disk apparatus.

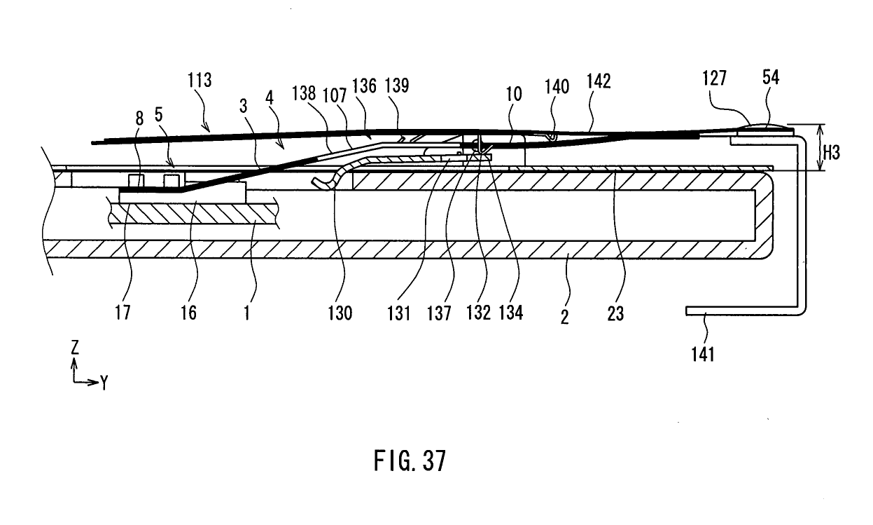

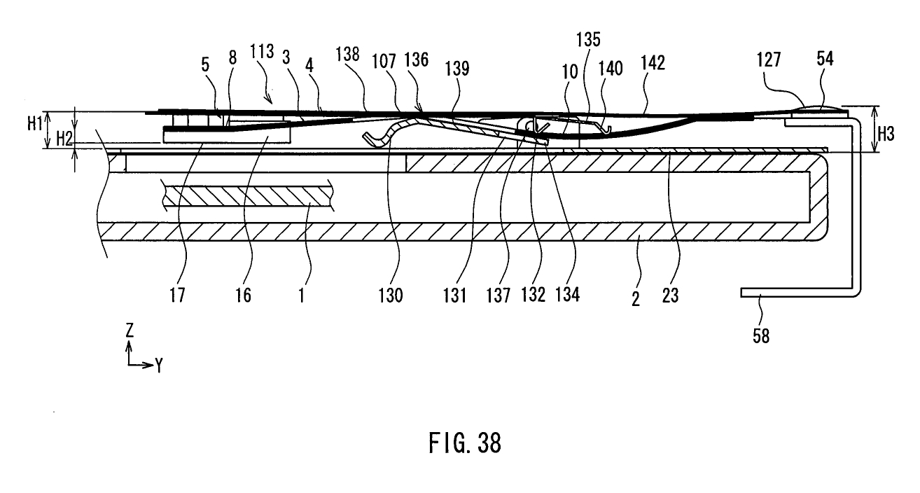

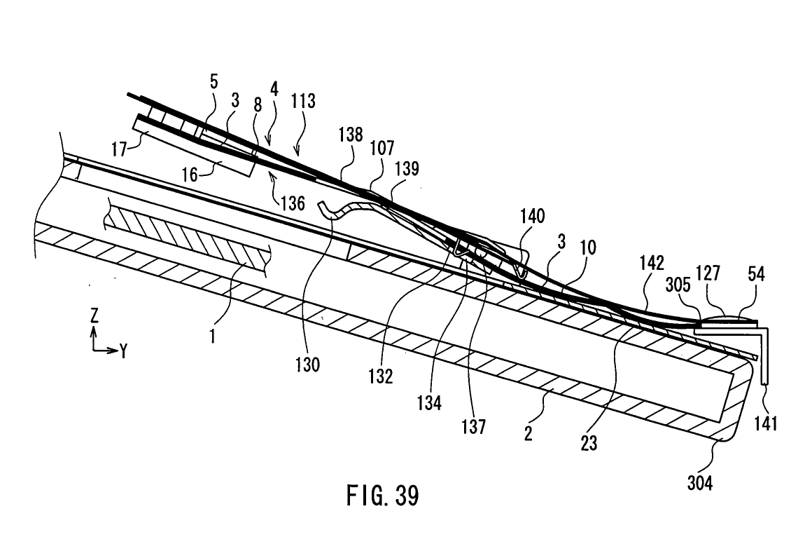

FIG. 36 is a plan view showing a magnetic head apparatus according to an eighth embodiment of the present invention. FIG. 37 is a plan view showing a main part of the magnetic head apparatus shown in FIG. 36; FIG. 38 is a cross-sectional side view showing the magnetic head apparatus in the first position taken on line X-X in FIG. 36; and FIG. 39 is a cross-sectional side view showing the magnetic head apparatus in the second position taken on line X-X in FIG. 36.

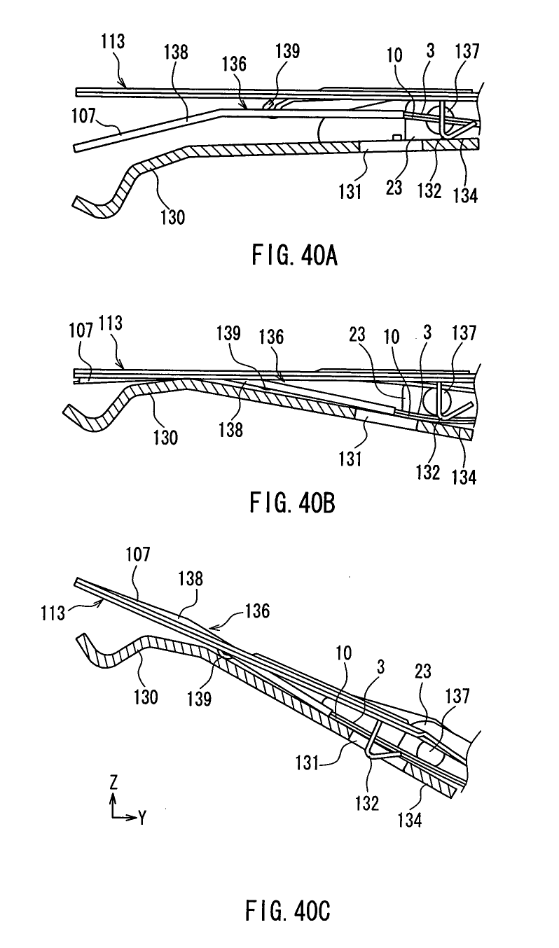

FIG. 40A is a cross-sectional side view showing a main part of the magnetic head apparatus in the first position taken on line X-X in FIG. 36; FIG. 40B is a cross-sectional side view showing a main part of the magnetic head apparatus in the second position taken on line X-X; and FIG. 40C is a cross-sectional side view showing a main part of the magnetic head apparatus in the third position taken on line X-X.

The magnetic head apparatus according to the eighth embodiment is characterized in that the magnetic head hoisting and lowering member 130 is provided with an evacuation hole portion 131 and in the third position of the magnetic head in which the magneto-optical disk 1 and the cartridge 2 are attached/detached to/from the magneto-optical disk apparatus, a holding portion 132 protruding toward the side of the magneto-optical disk 1 enters the evacuation hole portion 131.

The eighth embodiment is different from the seventh embodiment in the configuration in the third position but is the same as the seventh embodiment in the basic configuration and operations and effects. The difference between the eighth embodiment and the seventh embodiment will be mainly explained.

As shown in FIG. 36, as to the longitudinal direction of the supporting material 136, the evacuation hole portion 131 is provided in the magnetic head hoisting and lowering member 130 so that it is placed in the proximity of the posture holding portion 132. More specifically, as shown in FIGS. 40A and 40B, the posture holding portion 132 faces the flat surface portion 134 adjacent to the evacuation hole portion 131. Although details will be explained as follows, in the third position (FIG. 40C), this relationship will be changed.

As shown in FIGS. 37 and 40A, in the first position, the posture holding portion 132 is brought into contact with the flat surface portion 134, and the magnetic head pressing member 135 and the supporting material 136 are placed with space therebetween.

In the movement from the first position (FIG. 40A) to the second position (FIG. 40B), the magnetic head hoisting and lowering member 130 turns in a clockwise direction around the magnetic head hoisting and lowering turning axis 137 and is brought into contact with the interchange portion 138. At this time, the flat surface portion 134 moves toward the side of the magneto-optical disk 1 and is separated from the posture holding portion 132. At this time, furthermore, the magnetic head hoisting and lowering member 130 is brought into contact with the moving portion 139 via the holding material hole portion 51, and turns in a clockwise direction around the magnetic head pressing member 135. Thus, as shown in FIG. 37, the pressing portion 140 is brought into contact with the first spring system 10 and the first spring system 10 is deformed elastically.

In the movement from the second position to the third position (FIGS. 39 and 40C) in which the magneto-optical disk 1 and the cartridge 2 are attached/detached, the holder 23 turns in a clockwise direction around the X-axis as a turning axis near the linking member 141 in the proximity of the lower surface 304 of the cartridge 2.

Since the magnetic head hoisting and lowering member 130 is attached to the holder 23, the magnetic head hoisting and lowering member 130 turns together with the holder 23 around the same turning center as that of the holder 23.

On the other hand, the magnetic head holding member 113 is lifted by the head hoisting and lowering member 130 that turns together with the holder 23. Since the magnetic head holding elastic portion 142 of the magnetic head holding member 113 is fixed to the linking member 141 of a rigid substance, the center of turning movement of the magnetic head holding member 113 is in the vicinity of the boundary 305 between the magnetic head holding elastic portion 142 and the fixing material 54.

In this way, the turning center axis of the holder 23 and the turning center axis of the magnetic head holding member 113 are displaced from each other both in the y-direction and the z-axis direction. As shown in FIGS. 40B and 40C, the positional relationship in the y-direction between the posture holding portion 132 and the magnetic head hoisting and lowering member 130 are relatively moved.

Therefore, when the magnetic head 4 moves from the second position to the third position, as shown in FIG. 40A, the posture holding portion 132 that is in contact with the flat surface portion 134 in the first position enters the evacuation hole portion 131 as shown in FIG. 40C.

Thus, in the third position, a magnetic head holding member 113 is not lifted more than necessarily in the direction in which the tip is separated from the holder 23, so that the stress in the magnetic head holding elastic portion 142 can be reduced. Therefore, the reliability of the magnetic head apparatus including the third position can further be increased.

Note here that the evacuation hole portion 131 may be a concave portion that is concave with respect to the magneto-optical disk 1 or may be a notch although the example of the through hole was explained.

(Ninth Embodiment)

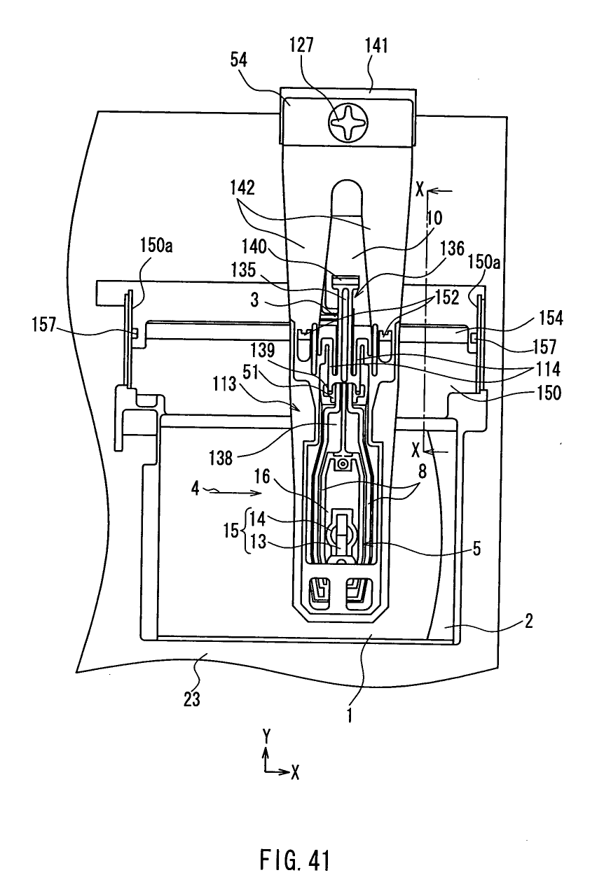

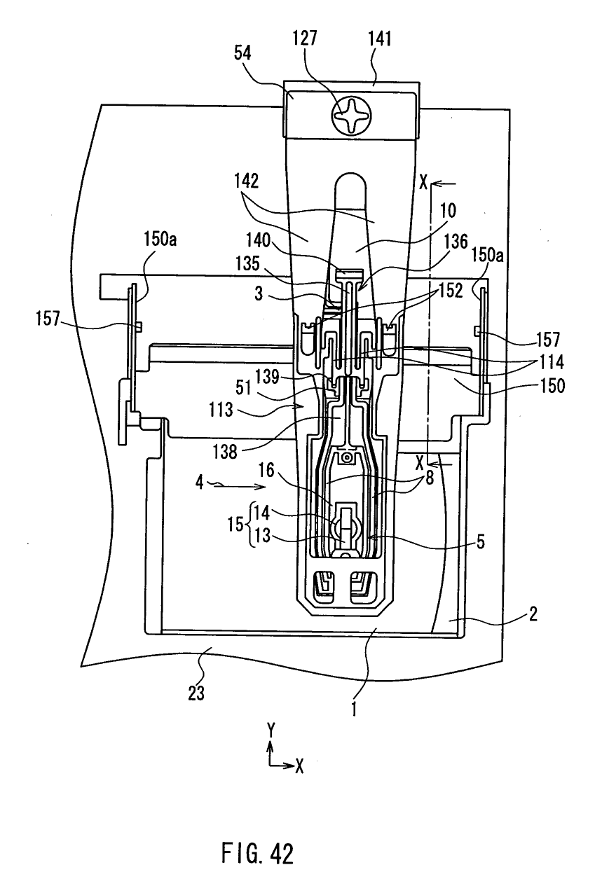

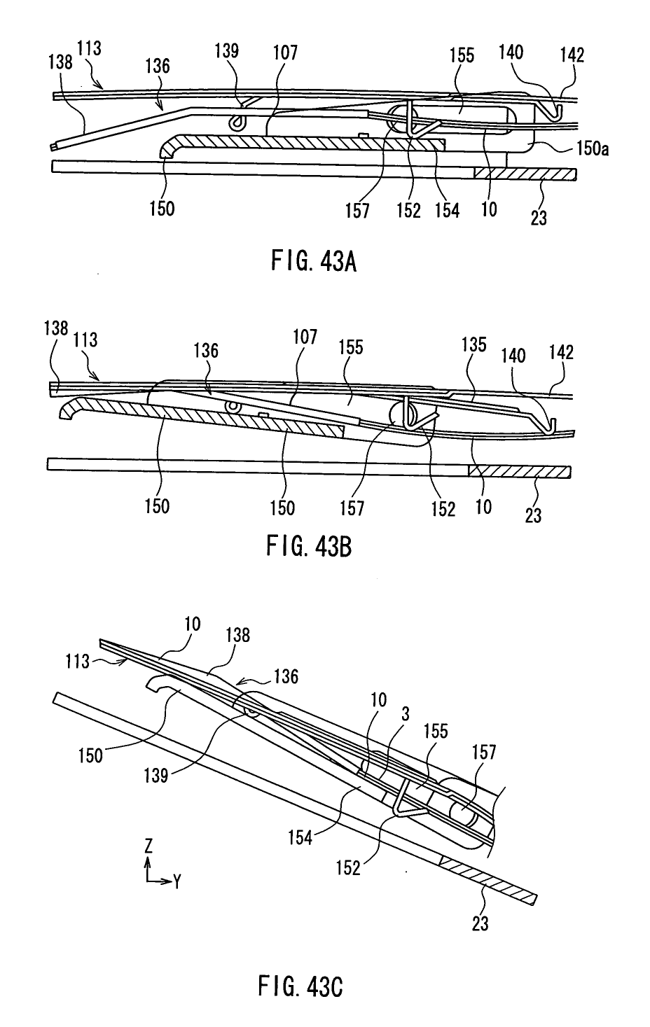

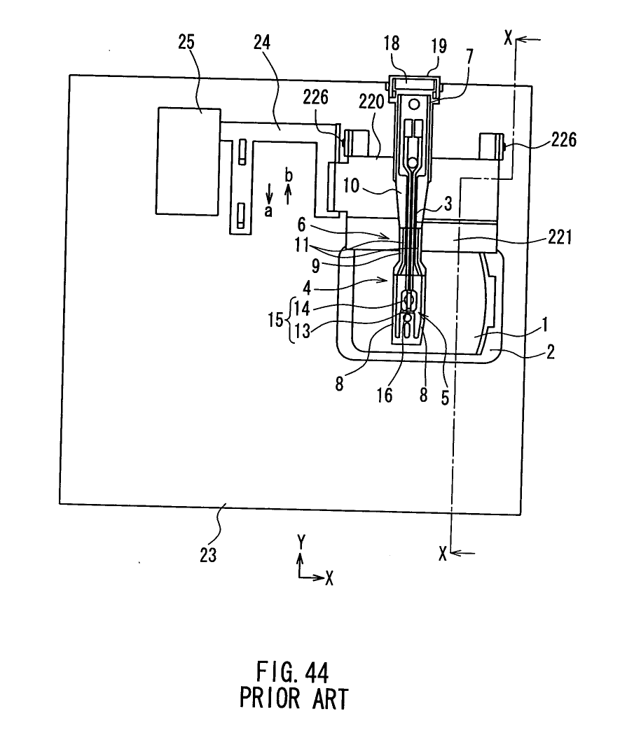

Hereinafter, a magnetic head apparatus according to the ninth embodiment will be explained with reference to FIGS. 41 to 43. FIG. 41 is a plan view showing a magnetic head apparatus in the first position in the ninth embodiment of the present invention; and FIG. 42 is a plan view showing a magnetic head apparatus in the second position in the ninth embodiment of the present invention. FIG. 43A is a cross-sectional side view showing a main part of the magnetic head apparatus in the first position taken on line X-X in FIG. 41; FIG. 43B is a cross-sectional side view showing a main part of the magnetic head apparatus in the second position taken on line X-X in FIG. 41; and FIG. 43C is a cross-sectional side view showing a main part of the magnetic head apparatus in the third position taken on line X-X in FIG. 41.

The magnetic head apparatus according to the ninth embodiment is characterized in that the magnetic head hoisting and lowering member 150 is attached to the holder 23 movably in the y-direction, and by moving the magnetic head hoisting and lowering member 150 toward the head main body during the movement of the magnetic head apparatus from the first position to the second position, the posture holding portion 152 protruding toward the magneto-optical disk 1 and the flat surface portion 154 are separated from each other.

The ninth embodiment is different from the eighth embodiment in the structure in which the magnetic head hoisting and lowering member 150 is attached but the same as the eighth embodiment in the basic configuration and operations and effects. The difference between the ninth embodiment and the eighth embodiment will be explained.

As shown in FIG. 43A, the magnetic head hoisting and lowering member 150 is provided with a long hole portion 155 having an elliptic shape that is long in the y-direction and is provided on a standing wall 150a (see FIG. 41) formed on both sides in the x-direction. And the magnetic head hoisting and lowering member 150 is attached to the holder 23 by allowing the long hole portion 155 to be engaged into the magnetic head hoisting and lowering parallel proceeding axis 157. The magnetic head hoisting and lowering member 150 is linked to a hoisting and lowering driving member (not shown).

In the first position as shown in FIG. 43A, the posture holding portion 152 is brought into contact with the flat surface portion 154 and defines the position of the magnetic head holding member 113 in the z-direction. Then, as shown in FIGS. 43A and 43B, when the magnetic head 4 moves from the first position to the second position, the magnetic head hoisting and lowering member 150 moves toward the side of the main body 5 in the y-direction while changing the relative position of the magnetic head hoisting and lowering parallel proceeding axis 157 and the long hole portion 155. With this movement in the y-direction, the posture holding portion 152 is separated from the flat surface portion 154 of the magnetic head hoisting and lowering member 150.

The magnetic head hoisting and lowering member 150 turns in a clockwise direction and is brought into contact with the interchange portion 138 and the moving portion 139 and then moves away from the magneto-optical disk 1 in the z-direction. Thus, the pressing portion 140 is brought into contact with the first spring system 10 and the first spring system 10 is elastically deformed.

Since the magnetic head hoisting and lowering member 150 moves in the y-direction toward the side of the main body 5, the magnetic head hoisting and lowering member 150 can lift the portion in the vicinity of the head main body 5 of the tilting interchange portion 138. Therefore, the head main body 5 can be separated surely from the magneto-optical disk 1.

Furthermore, in the third position, due to the displacement of the turning center of the magnetic head holding portion 113 and the holder 23, the posture holding portion 152 approaches the flat surface portion 154. However, by securing the amount of movement of the magnetic head hoisting and lowering member 150 in the y-direction, as shown in FIG. 43C, the posture holding portion 152 does not run upon the flat surface portion 154.

As mentioned above, according to the magnetic head apparatus of the ninth embodiment, in the second position and the third position, the head main body 5 is more reliably separated from the magneto-optical disk 1, so that at the time of movement in the radius direction of the magnetic head apparatus 4 in the second position or when the magneto-optical disk 1 is attached/detached in the third position, the possibility of the head main body 5 being brought into contact with the cartridge 2 is reduced. Thus, the reliability of the magnetic head apparatus can further be improved.

The invention may be embodied in other specific forms without departing from the spirit or essential characteristics thereof. The embodiments disclosed in this application are to be considered in all respects as illustrative and not restrictive, the scope of the invention being indicated by the appended claims rather than by the foregoing description, all changes that come within the meaning and range of equivalency of the claims are intended to be embraced therein.

What is claimed is:

1. A magnetic head apparatus, comprising:
a supporting material comprising a head main body for applying a magnetic field to an information recording medium attached to one end with a second end fixed, and an elastic portion, which is capable of being elastically deformed, between the head main body and the fixed second end;
a magnetic head hoisting and lowering member disposed between the supporting material and the information recording medium and fixed in a manner capable of being brought into contact with and separating from the supporting material; and
a magnetic head pressing member comprising a pressing portion facing a surface opposite side to the information recording medium in both sides of the supporting material and fixed in a manner capable of being brought into contact with and separating from the supporting material,
wherein the head main body is capable of moving between a first position in which the head main body approaches or is brought into contact with the information recording medium so as to record or reproduce information and a second position in which the head main body is far away from the information recording medium as compared with the first position,
while the head main body moves from the first position to the second position, the magnetic head hoisting and lowering member approaches and is brought into contact with the supporting material; and the pressing portion of the magnetic head pressing member approaches the supporting material and is brought into contact with the elastic portion,
a position in which the pressing portion and the elastic portion are contact with each other is closer to the side of the fixing position of the supporting material than the position in which the magnetic head hoisting and lowering member and the supporting material are brought into contact with each other; and
in the second position, the pressing portion presses the elastic portion, so that the elastic portion is elastically deformed toward the side of the information recording medium.

2. The magnetic head apparatus according to claim 1, further comprising: a magnetic head holding member being substantially in parallel with the surface of the information recording medium, having one end fixed, and being disposed facing a surface opposite side to the information recording medium in both faces of the supporting material, wherein the magnetic head pressing member is provided in the magnetic head holding member.

3. The magnetic head apparatus according to claim 2, wherein the magnetic head pressing member is linked to the magnetic head holding member via a magnetic head pressing elastic portion capable of being elastically deformed.

4. The magnetic head apparatus according to claim 3, wherein the magnetic head pressing elastic portion is configured by a plurality of plate springs disposed substantially in parallel with each other in the longitudinal direction of the supporting material.

5. The magnetic head apparatus according to claim 2, wherein in the second position, in both ends in the longitudinal direction of the supporting material of the magnetic head pressing member, one end moves in the direction of going away from the information recording medium and is in contact with the supporting material, and another end moves in the direction of approaching the information recording medium and is in contact with the elastic portion of the supporting material.

6. The magnetic head apparatus according to claim 2, wherein in the second position, in both ends in the longitudinal direction of the supporting material of the magnetic head pressing member, one end moves in the direction of going far away from the information recording medium and is in contact with the magnetic head hoisting and lowering member, and another end moves in the direction of approaching the information recording medium and is in contact with the elastic portion of the supporting material.

7. The magnetic head apparatus according to claim 6, wherein a supporting material hole portion is provided between the supporting material elastic portion of the supporting material and the head main body, and one end of the magnetic head pressing member is brought into contact with the magnetic head hoisting and lowering member by penetrating one end of the magnetic head pressing member through the supporting material hole portion.

8. A magnetic head apparatus, comprising:
a supporting material comprising a head main body for applying a magnetic field to an information recording medium attached to one end with a second end fixed, and a first elastic portion, which is capable of being elastically deformed, between the head main body and the fixed second end;
a magnetic head hoisting and lowering member disposed between the supporting material and the information recording medium and fixed in a manner capable of being brought into contact with and separating from the supporting material;
a magnetic head holding member comprising a second elastic portion capable of being elastically deformed, being substantially in parallel with the surface of the information recording medium, having one end at the side of the second elastic portion being fixed, and disposed facing the surface at the opposite side to the information recording medium; and
a posture holding member provided in the magnetic head holding member and protruding toward the side of the information recording medium so as to face the magnetic head hoisting and lowering member,
wherein the head main body is capable of moving between a first position in which the head main body approaches or is brought into contact with the information recording medium so as to record or reproduce information and a second position in which the head main body is far away from the information recording medium as compared with the first position, and
in the first position, the posture holding portion is brought into contact with the magnetic head hosting and lowering member.

9. The magnetic head apparatus according to claim 8, wherein at least one of the posture holding portion and the magnetic head hoisting and lowering member comprises a flat surface portion that is substantially in parallel with the surface of the information recording medium and in the first position, the flat surface portion is brought into contact with the posture holding portion or the magnetic head hoisting and lowering member.

10. The magnetic head apparatus according to claim 8, wherein the magnetic head hoisting and lowering member turns around an axis as a center, which is substantially in parallel with the surface of the information recording medium and substantially perpendicular to the longitudinal direction of the supporting material, and in the first position, at the side closer to the end at which the magnetic head holding member is fixed with respect to the center, the posture holding portion is brought into contact with the magnetic head hoisting and lowering member.

11. The magnetic head apparatus according to claim 9, wherein the magnetic head holding member is provided with a magnetic head pressing member, while the head main body moves from the first position to the second position, one end of the magnetic head pressing member is brought into contact with the supporting material or the magnetic head hoisting and lowering member and moves in the direction away from the information recording medium,
another end of the magnetic head pressing member approaches the supporting material and is brought into contact with the first elastic portion so as to elastically deform the first elastic portion toward the side of the information recording medium in the second position, and
in the second position, the posture holding portion is separated from the magnetic head hoisting and lowering member.

12. The magnetic head apparatus according to claim 8, wherein the magnetic head hoisting and lowering member is provided with an evacuation portion in which a concave portion which is concave toward the side of the information recording medium or a through hole or a notch is formed; and
when the information recording medium is tilted so as to make the position in which the information recording medium is attached/detached be a third position, in the third position, the posture holding portion is evacuated in the evacuation portion.

13. The magnetic head apparatus according to claim 8, wherein while the head main body moves from the first position to the second position, the magnetic head hoisting and lowering member moves in the longitudinal direction of the supporting material and the posture holding portion and the magnetic head hoisting and lowering member are separated from each other.
